(19) United States
(12) Patent Application Publication
(10) Pub. No.: US 2026/0197693 A1
(43) Pub. Date: Jul. 9, 2026

(54) METHOD AND APPARATUS FOR STORING AND REPORTING OF HSDN INDICATOR IN WIRELESS COMMUNICATION SYSTEM

(71) Applicant: Samsung Electronics Co., Ltd., Suwon-si (KR)

(72) Inventors: Sangyeob JUNG, Suwon-si (KR); Seungri JIN, Suwon-si (KR)

(21) Appl. No.: 19/439,180

(22) Filed: Jan. 2, 2026

(30) Foreign Application Priority Data
Jan. 3, 2025 (KR) 10-2025-0000712
Apr. 23, 2025 (KR) 10-2025-0052857

(51) Int. Cl. H04W 24/10; H04W 88/06

(52) U.S. Cl. CPC H04W 24/10; H04W 88/06

(57) ABSTRACT

The disclosure relates to a 5G or 6G communication system for supporting a higher data transmission rate.

### CROSS-REFERENCE TO RELATED APPLICATIONS

This application is based on and claims priority under 35 U.S.C. § 119 to Korean Patent Application Nos. 10-2025-0000712 and 10-2025-0052857 filed on Jan. 3, 2025, and Apr. 23, 2025, in the Korean Intellectual Property Office, the disclosure of which is herein incorporated by reference in their entirety.

### BACKGROUND

### 1. Field

The disclosure relates to operations of a UE and a base station in a wireless communication system. More specifically, the disclosure relates to a method and an apparatus for storing and reporting an indicator related to a high speed dedicated network in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The technical subjects pursued in the disclosure may not be limited to the above-mentioned technical subjects, and other technical subjects which are not mentioned herein may be clearly understood from the following description by those skilled in the art to which the disclosure pertains.

An embodiment of the disclosure provides an apparatus and a method capable of effectively providing services in a wireless communication system.

Advantageous effects obtainable from the disclosure may not be limited to the above-mentioned effects, and other effects which are not mentioned herein may be clearly understood from the following description by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a structure of an LTE system according to an embodiment of the disclosure;

FIG. 1B illustrates a radio protocol structure in an LTE system according to an embodiment of the disclosure;

FIG. 1C illustrates a structure of a wireless communication system according to an embodiment of the disclosure;

FIG. 1D illustrates a radio protocol structure of a wireless communication system according to an embodiment of the disclosure;

FIG. 1E illustrates a diagram depicting a procedure in which a UE in a radio resource control (RRC) connected mode (RRC_CONNECTED) in a wireless communication system transmits a measurement report message to a base station for automatic neighbor cell relation (ANR) according to an embodiment of the disclosure;

FIG. 1F illustrates a diagram depicting a procedure in which a UE in an RRC connected mode in a wireless communication system transmits an indicator indicating a high speed dedicated network (HSDN) cell to a base station for the sake of ANR through a measurement report message according to an embodiment of the disclosure;

FIG. 1G illustrates a diagram depicting a procedure in which a UE in an RRC connection mode in a wireless communication system transmits an indicator indicating an HSDN cell to a base station for the sake of ANR through a measurement report message according to an embodiment of the disclosure;

FIG. 1H illustrates a diagram depicting a procedure in which a UE in an RRC connection mode in a wireless communication system transmits an indicator indicating an HSDN cell to a base station for the sake of ANR through a measurement report message according to an embodiment of the disclosure;

FIG. 1I illustrates a diagram depicting a procedure in which a UE in an RRC connection mode in a wireless communication system transmits an indicator indicating an HSDN cell to a base station for the sake of ANR through a measurement report message according to an embodiment of the disclosure;

FIG. 1J illustrates a flowchart depicting a UE in an RRC connected mode performing measurement logging in a wireless communication system according to an embodiment of the disclosure;

FIG. 1K illustrates a block diagram depicting a structure of an NR base station according to an embodiment of the disclosure; and

FIG. 1L illustrates an internal structure of a UE according to an embodiment of the disclosure.

### DETAILED DESCRIPTION

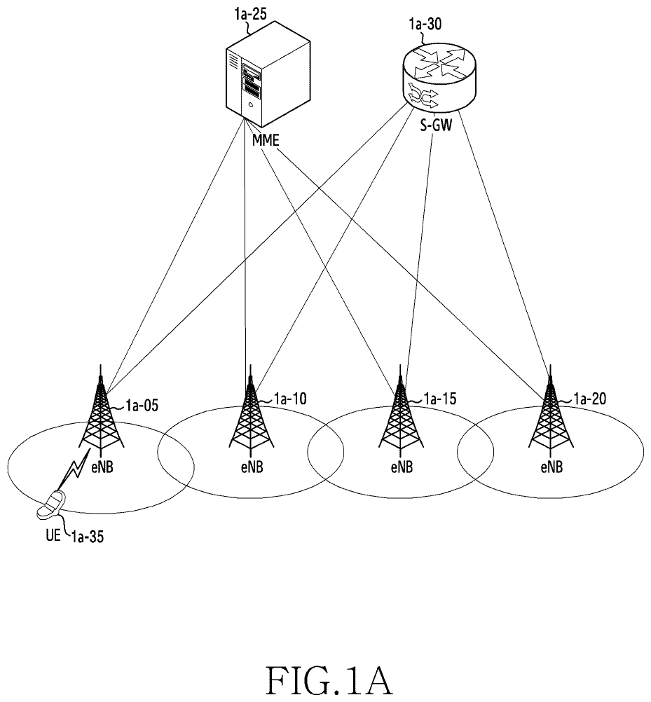

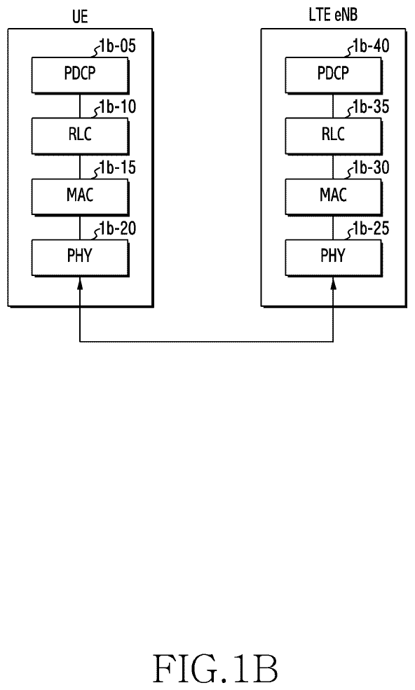

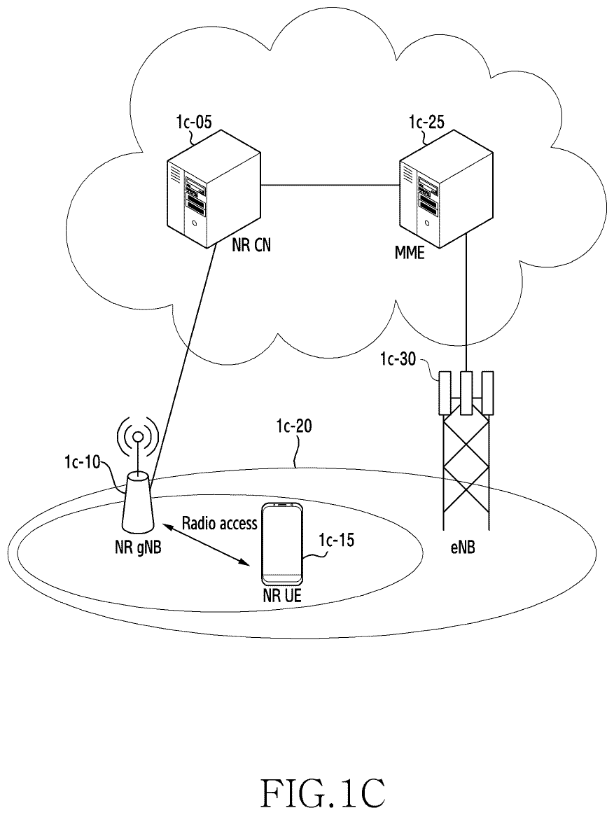

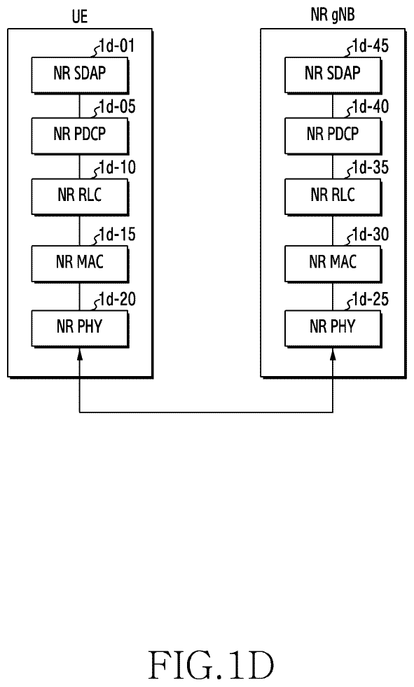

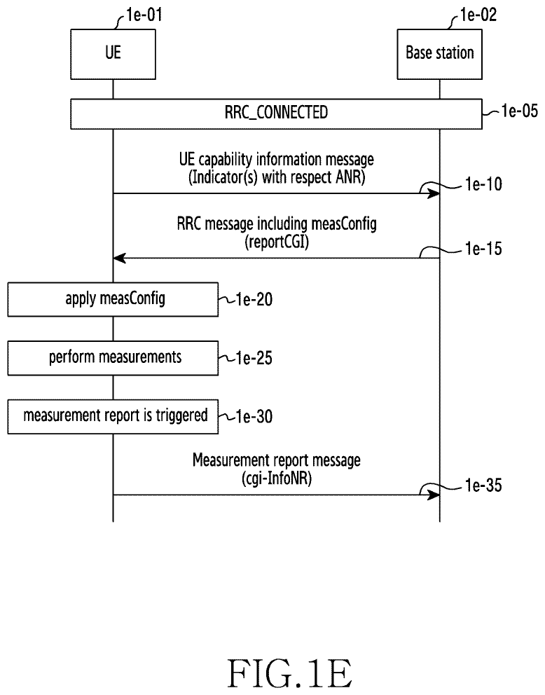

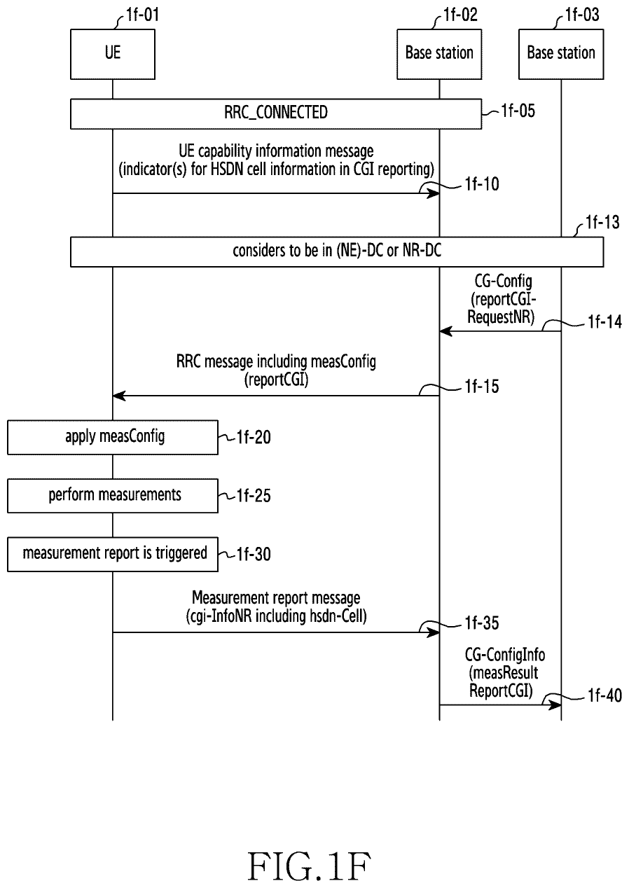

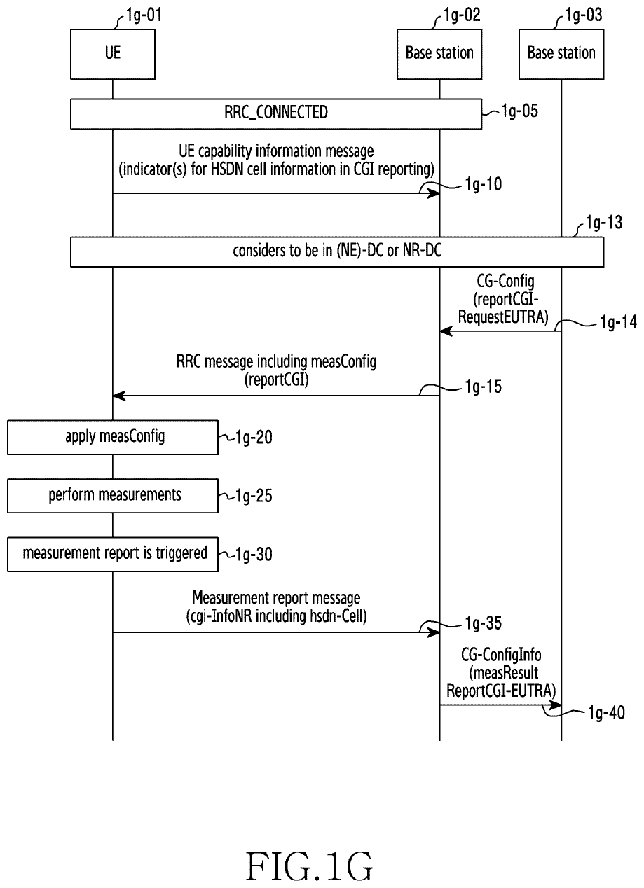

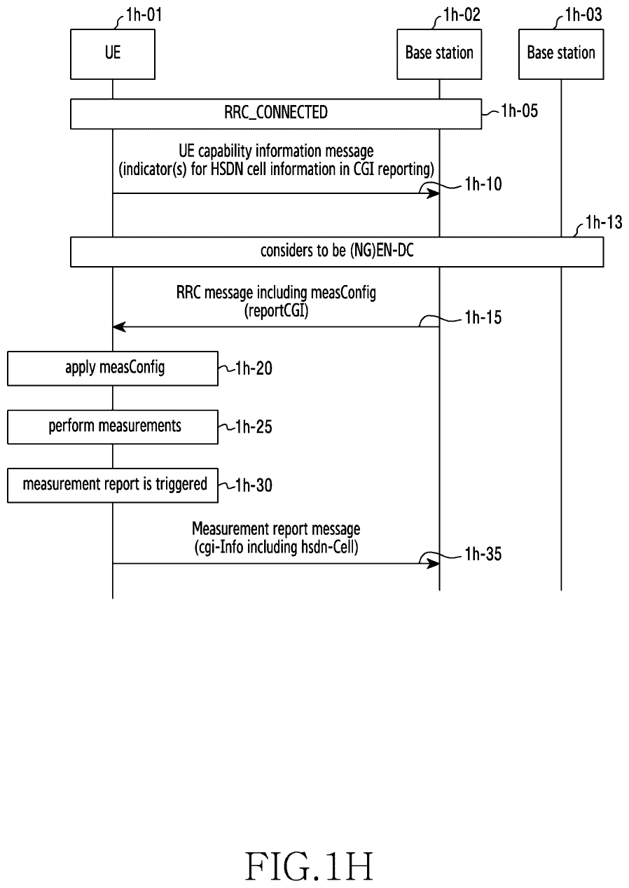

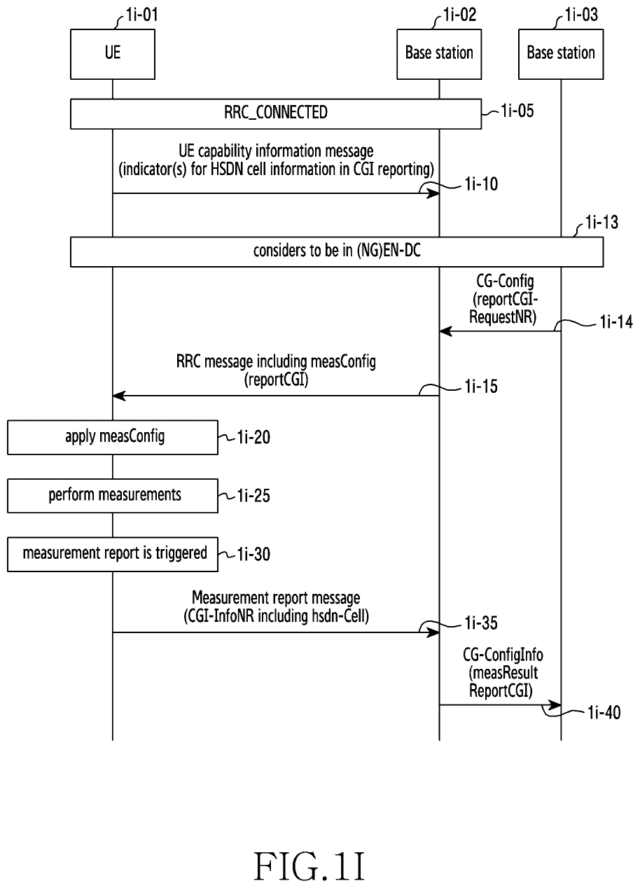

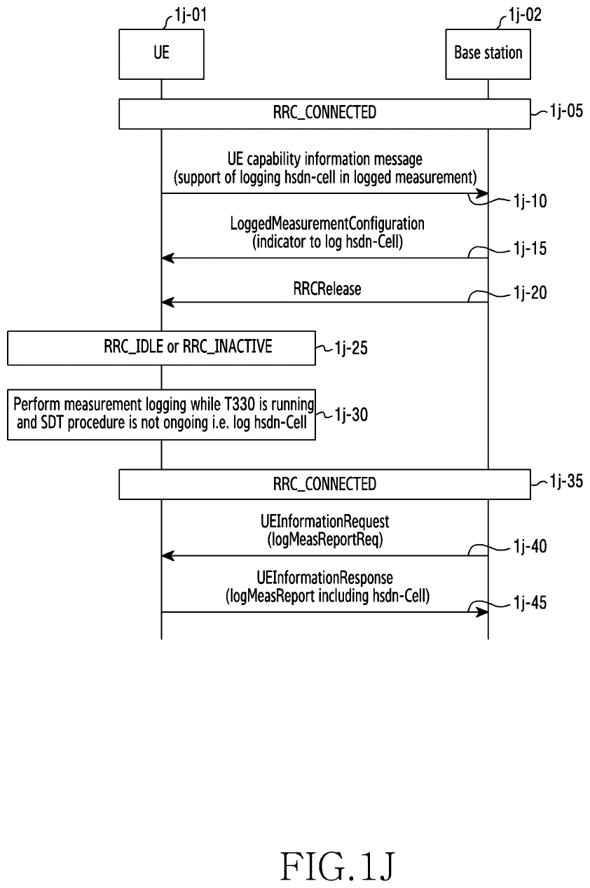

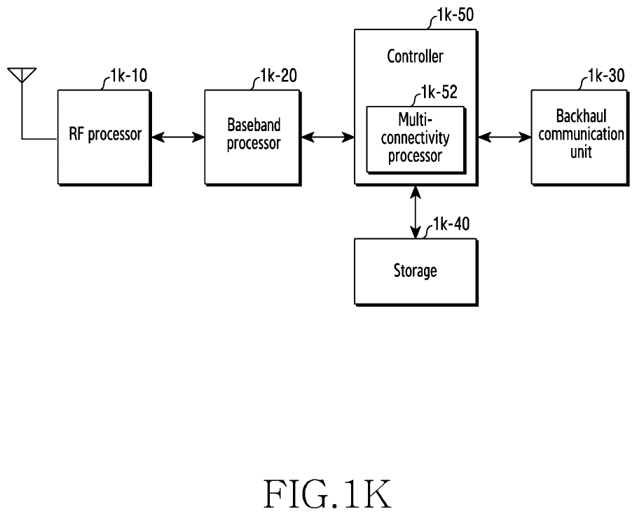

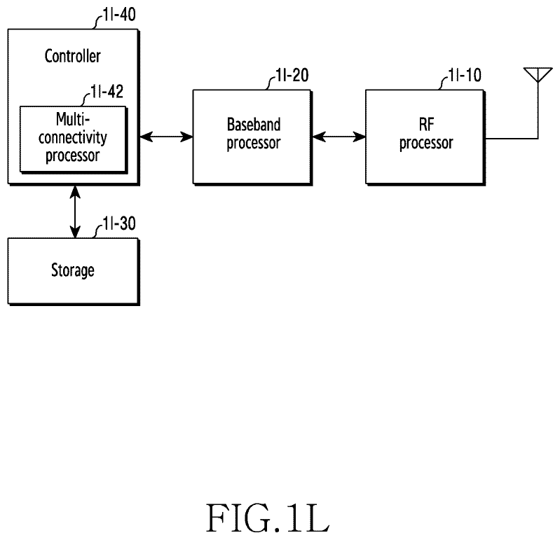

FIGS. 1A through 1L, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments of the disclosure may include one or more processors.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). The disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “evolved node B (eNB)” may be interchangeably used with the term “next generation Node B (gNB)” for the sake of descriptive convenience. That is, a base station described as “eNB” may indicate “gNB”. In addition, the term “terminal” may refer to not only mobile phones, NB-IoT devices, and sensors, but also other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), Institute of Electrical and Electronics Engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

FIG. 1A illustrates a structure of an LTE system according to an embodiment of the disclosure.

Referring to FIG. 1A, as illustrated therein, a radio access network of an LTE system includes next-generation base stations (evolved Node Bs, hereinafter ENBs, Node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 accesses an external network through the ENBs 1a-05 to 1a-20 and the S-GW 1a-30.

In FIG. 1A, the ENBs 1a-05 to 1a-20 may correspond to conventional Node Bs of the universal mobile telecommunication system (UMTS). The ENBs are connected to the UE 1a-35 through a radio channel, and perform more complicated roles than the conventional Node Bs. In the LTE system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is utilized, and the ENBs 1a-05 to 1a-20 serve as such a device. In general, one ENB controls multiple cells. For example, in order to implement a transfer rate of 100 Mbps, the LTE system uses orthogonal frequency division multiplexing (hereinafter referred to as OFDM) as a radio access technology in a bandwidth of, for example, 20 MHz. Obviously, the above example is not limiting. Furthermore, the ENBs 1a-05 to 1a-20 employ an adaptive modulation & coding (hereinafter referred to as AMC) scheme for determining a modulation scheme and a channel coding rate according to a channel state of a UE. The S-GW 1a-30 is a device that provides a data bearer, and generates or removes a data bearer under the control of the MME 1a-25. The MME is a device responsible for various control functions, as well as a mobility management function for a UE, and is connected to multiple base stations.

FIG. 1B illustrates a radio protocol structure in an LTE system according to an embodiment of the disclosure.

Referring to FIG. 1B, a radio protocol of an LTE system includes a packet data convergence protocol (PDCP) 1b-05 or 1b-40, a radio link control (RLC) 1b-10 or 1b-35, a medium access control (MAC) 1b-15 or 1b-30, and a physical layer 1b-20 or 1b-25 on each of UE and ENB sides. Of course, the radio protocol of the LTE system may include a larger or smaller number of layers than those of the structure illustrated in FIG. 1B. The packet PDCP 1b-05 or 1b-40 is responsible for operations such as IP header compression/reconstruction. According to an embodiment of the disclosure, the PDCP may serve to perform operations, such as IP header compression/reconstruction. The main functions of the PDCP are summarized as follows. Obviously, the examples given below are not limiting.
Header compression and decompression: robust header compression (ROHC) only
Transfer of user data
In-sequence delivery of upper layer PDUs at PDCP re-establishment procedure for RLC acknowledged mode (AM)
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

According to an embodiment of the disclosure, the radio link control (hereinafter referred to as RLC) 1b-10 or 1b-35 reconfigures a PDCP protocol data unit (PDU) into appropriate sizes to perform an ARQ operation. The main functions of the RLC are summarized as follows. Obviously, the examples given below are not limiting.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

According to an embodiment of the disclosure, the MAC 1b-15 or 1b-30 is connected to several RLC layer devices configured in a single UE, and multiplexes RLC PDUs into an MAC PDU and demultiplex RLC PDUs from an MAC PDU. The main functions of the MAC are summarized as follows. Obviously, the examples given below are not limiting.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

According to an embodiment of the disclosure, the physical layer 1b-20 or 1b-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. Obviously, the examples given below are not limiting.

FIG. 1C illustrates a structure of a wireless communication system according to an embodiment of the disclosure.

Referring to FIG. 1C, as illustrated therein, a radio access network of a wireless communication system (hereinafter NR or 5G) includes a next-generation base station (new radio Node B, hereinafter NR gNB or NR base station) 1c-10, and a new radio core network (NR CN) 1c-05. A user equipment (new radio user equipment, hereinafter NR UE or NR terminal) 1c-15 accesses an external network via the NR gNB 1c-10 and the NR CN 1c-05.

In FIG. 1C, the NR gNB 1c-10 corresponds to an evolved Node B (eNB) of the conventional LTE system. The NR gNB is connected to the NR UE 1c-15 through a radio channel, and can provide outstanding services as compared to other node Bs. In the wireless communication system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is utilized, and the NR gNB 1c-10 serves as such device. In general, one NR gNB controls multiple cells. In order to implement ultrahigh-speed data transfer beyond the current LTE, the wireless communication system may provide a wider bandwidth than the existing maximum bandwidth, employ an orthogonal frequency division multiplexing (hereinafter referred to as OFDM) as a radio access technology, and additionally integrate a beamforming technology therewith. Furthermore, the wireless communication system employs an adaptive modulation and coding (hereinafter referred to as AMC) scheme for determining a modulation scheme and a channel coding rate according to a channel state of a UE. The NR CN 1c-05 performs functions such as mobility support, bearer configuration, and QoS configuration. The NR CN 1c-05 is a device responsible for various control functions, as well as a mobility management function for a UE, and is connected to multiple base stations. In addition, the wireless communication system may interwork with the LTE system, and the NR CN 1c-05 is connected to an MME 1c-25 via a network interface. The MME 1c-25 may be connected to an eNB 1c-30 that is a base station.

FIG. 1D illustrates a radio protocol structure of a wireless communication system according to an embodiment of the disclosure.

Referring to FIG. 1D, a radio protocol of a wireless communication system may include an NR SDAP 1d-01 or 1d-45, an NR PDCP 1d-05 or 1d-40, an NR RLC 1d-10 or 1d-35, an NR MAC 1d-15 or 1d-30, and NR PHY 1d-20 or 1d-25 on each of UE and NR gNB sides. Of course, the radio protocol of the wireless communication system may include a larger or smaller number of layers than those of the structure illustrated in FIG. 1D.

According to an embodiment of the disclosure, the main functions of the NR SDAP 1d-01 or 1d-45 may include some of functions below. Obviously, the examples given below are not limiting.
Transfer of user plane data
Mapping between a QoS flow and a DRB for both DL and UL
Marking QoS flow ID in both DL and UL packets
Reflective QoS flow to DRB mapping for UL SDAP PDUs

With regard to the SDAP layer device 1d-01 or 1d-45, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

According to an embodiment of the disclosure, the main functions of the NR PDCP 1d-05 or 1d-40 may include some of functions below. Obviously, the examples given below are not limiting.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

Among the above functions, the reordering of the NR PDCP device 1d-05 or 1d-40 may refer to a function of reordering PDCP PDU received from a lower layer in an order based on PDCP sequence numbers (SNs). The reordering of the NR PDCP device 1d-05 or 1d-40 may include at least one of a function of transferring data to an upper layer according to a rearranged order, a function of directly transferring data without considering order, a function of rearranging order to record lost PDCP PDUs, a function of reporting the state of lost PDCP PDUs to a transmission side, or a function of requesting retransmission of lost PDCP PDUs.

According to an embodiment of the disclosure, the main functions of the NR RLC 1d-10 or 1d-35 may include some of functions below. Obviously, the examples given below are not limiting.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

Among the above functions, the in-sequence delivery of the NR RLC device 1d-10 or 1d-35 may refer to a function of successively delivering RLC SDUs, received from the lower layer, to the upper layer. The in-sequence delivery of the NR RLC device 1d-10 or 1d-35 may include at least one of a function of (if one original RLC SDU is divided into several RLC SDUs and the RLC SDUs are received) reassembling the several RLC SDUs and delivering the reassembled RLC SDUs, a function of rearranging received RLC PDUs with reference to RLC sequence numbers (SNs) or PDCP SNs, a function of rearranging order to record lost RLC PDUs, a function of reporting the state of lost RLC PDUs to a transmission side, a function of requesting retransmission of lost RLC PDUs, a function of (if there is a lost RLC PDU) delivering only RLC SDUs before the lost RLC PDU to the upper layer in sequence, a function of (although there is a lost RLC SDU, if a predetermined timer has expired) sequentially delivering, to an upper layer, all the RLC SDUs received before the timer is started, or a function of (although there is a lost RLC SDU, if a predetermined timer has expired) sequentially delivering all the RLC SDUs received up to the current to an upper layer. In addition, the in-sequence delivery of the NR RLC device 1d-10 or 1d-35 may process RLC PDUs in the received order (regardless of the sequence number order, in the order of arrival) and deliver same to the PDCP device regardless of the order (out-of-sequence delivery), and may, in the case of segments, receive segments which are stored in a buffer or which are to be received later, reconfigure same into one complete RLC PDU, process, and deliver same to the PDCP device. The NR RLC layer may include no concatenation function, which may be performed in the NR MAC layer or replaced with a multiplexing function of the NR MAC layer.

Among the above functions, the out-of-sequence delivery of the NR RLC device 1d-10 or 1d-35 may refer to a function of directly delivering RLC SDUs received from the lower layer to the upper layer regardless of the sequence. The out-of-sequence delivery of the NR RLC device 1d-10 or 1d-35 may include at least one of a function of, if one original RLC SDU is segmented into multiple RLC SDUs and the segmented RLC SDUs are received, reassembling the RLC SDUs and delivering the reassembled RLC SDUs, and a function of storing the RLC SN (sequence number) or PDCP SN (sequence number) of received RLC PDUs, and recording RLC PDUs lost as a result of reordering.

According to an embodiment of the disclosure, the NR MAC 1d-15 or 1d-30 may be connected to multiple NR RLC layer devices configured in one UE, and the main functions of the NR MAC 1d-15 or 1d-30 may include at least some of functions below. Obviously, the examples given below are not limiting.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR physical layer (PHY) 1d-20 or 1d-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

FIG. 1E is a diagram illustrating a procedure in which a UE in an RRC connected mode (RRC_CONNECTED) in a wireless communication system transmits a measurement report message to a base station for the purpose of an automatic neighbour cell relation (or ANR) according to an embodiment of the disclosure.

The ANR may be intended to reduce the burden on base station operators in passively managing the neighbor cell relation (NCR). For example, the base station may cause the UE to detect whether there is a cell that a specific physical cell identity (PCI) in the vicinity, to acquire information needed by the base station from the detected cell, and to report the same to the base station, thereby managing the NCR, based on information provided from the UE.

Referring to FIG. 1E, the UE 1e-01 may be in an RRC connected mode (RRC_CONNECTED) by establishing an RRC connection (1e-05) with the base station 1e-02.

In step 1e-10, the UE 1e-01 may transmit a UE capability information message (e.g., UECapabilityInformation) to the base station 1e-02 through a UE capability transfer procedure. The UE capability information message may include a predetermined capability parameter related to whether ANR is supported. For example, the predetermined capability parameter may include at least one of indicators indicating whether the UE is capable of reading system information (SI) from a neighboring intra-frequency or inter-frequency NR cell, acquiring information related to a cell global identity (CGI), and reporting the acquired information to the base station (e.g., including at least one of nr-CGI-Reporting, nr-CGI-Reporting-ENDC, nr-CGI-Reporting-NEDC, or nr-CGI-Reporting-NRDC), indicators indicating whether the UE is capable of reading system information from a neighboring intra-frequency or inter-frequency NR cell, acquiring a gNB ID length, and reporting the acquired information to the base station (e.g., including at least one of gNB-ID-Length-Reporting, gNB-ID-Length-Reporting-ENDC, gNB-ID-Length-Reporting-NEDC, or gNB-ID-Length-Reporting-NR-DC), indicators indicating whether the UE is capable of reading system information from a neighboring E-UTRA cell, acquiring information related to CGI, and reporting the acquired information to the base station (e.g., including at least one of eutra-CGI-Reporting, eutra-CGI-Reporting-NEDC, or eutra-CGI-Reporting-NRDC), an indicator indicating whether the UE is capable of reading system information from a neighboring intra-frequency or inter-frequency NR non-public network (NPN) cell, acquiring CGI information related to NPN, and reporting the acquired information to the base station (e.g., nr-CGI-Reporting-NPN), and indicators indicating whether the UE is capable of reading system information from a neighboring NR cell through an autonomous gap by means of a configuration (useAutonomousGaps) for the base station to use autonomous gaps, acquiring information related to the cell, and reporting the acquired information to the base station (e.g., including at least one of nr-AutonomousGaps-ENDC, nr-AutonomousGaps-NEDC, or nr-AutonomousGaps-NRDC). Specifically, the above parameters may refer to those indicated in Table 1-1 below. Obviously, the following examples are not limiting.

TABLE 1-1

| | | | FDD − | FR1 − |
|---|---|---|---|---|
| | | | TDD | FR2 |
| Definitions for parameters | Per | M | DIFF | DIFF |
| eutra-CGI-Reporting | UE | CY | No | No |
| Defines whether the UE supports acquisition | | | | |
| of relevant CGI-information from a neighbouring E- | | | | |
| UTRA cell by reading the SI of the neighbouring cell | | | | |
| and reporting the acquired information to the network | | | | |
| as specified in 3GPP technical specification (TS) | | | | |
| 38.331 (TS 38.331) when the (NG)EN-DC and NE-DC | | | | |
| are not configured or, when consistent DRX is | | | | |
| configured in NR-DC. The consistent DRX | | | | |
| configuration implies that MN (master node) and SN | | | | |
| (secondary node) have the same DRX cycle and on- | | | | |
| duration configured by MN completely contains on- | | | | |
| duration configured by SN. It is mandated if the UE | | | | |
| supports EUTRA. It is optional for (e)RedCap UEs. | | | | |
| eutra-CGI-Reporting-NEDC | UE | No | No | No |
| Defines whether the UE supports acquisition | | | | |
| of relevant information from a neighbouring E-UTRA | | | | |
| cell by reading the SI of the neighbouring cell and | | | | |
| reporting the acquired information to the network as | | | | |
| specified in TS 38.331 when the NE-DC is configured. | | | | |
| eutra-CGI-Reporting-NRDC | UE | No | No | No |
| Defines whether the UE supports acquisition | | | | |
| of relevant information from a neighbouring E-UTRA | | | | |
| cell by reading the SI of the neighbouring cell and | | | | |
| reporting the acquired information to the network as | | | | |
| specified in TS 38.331 when the NR-DC is configured | | | | |
| wherein MN and SN have different DRX cycles, or on- | | | | |
| duration configured by MN does not contain on- | | | | |
| duration configured by SN if the DRX cycles are the | | | | |
| same. | | | | |
| gNB-ID-LengthReporting-r17 | UE | CY | No | No |
| Indicates whether the UE supports acquisition | | | | |
| and reporting of gNB ID length from a neighbouring | | | | |
| intra-frequency or inter-frequency NR cell by reading | | | | |
| the SI of the neighbouring cell and reporting the | | | | |
| acquired gNB ID length to the network as specified in | | | | |
| TS 38.331 when (NG)EN-DC and NE-DC are not | | | | |
| configured or, when consistent DRX is configured in | | | | |
| NR-DC. The consistent DRX configuration implies that | | | | |
| MN and SN have the same DRX cycle and on-duration | | | | |
| configured by MN completely contains on-duration | | | | |
| configured by SN. It is mandated if UE supports NR | | | | |
| CGI reporting (NG)EN-DC and NE-DC are not | | | | |
| configured or, when consistent DRX is configured in | | | | |
| NR-DC. | | | | |
| gNB-ID-LengthReporting-ENDC-r17 | UE | CY | No | No |
| Indicates whether the UE supports acquisition | | | | |
| and reporting of gNB ID length from a neighbouring | | | | |
| intra-frequency or inter-frequency NR cell by reading | | | | |
| the SI of the neighbouring cell and reporting the | | | | |
| acquired gNB ID length to the network as specified in | | | | |
| TS 38.331 when the (NG)EN-DC is configured. It is | | | | |
| mandated if UE supports NR CGI reporting when | | | | |
| (NG)EN-DC is configured. | | | | |
| gNB-ID-LengthReporting-NEDC-r17 | UE | CY | No | No |
| Indicates whether the UE supports acquisition | | | | |
| and reporting of gNB ID length from a neighbouring | | | | |
| intra-frequency or inter-frequency NR cell by reading | | | | |
| the SI of the neighbouring cell and reporting the | | | | |
| acquired gNB ID length to the network as specified in | | | | |
| TS 38.331 when the NE-DC is configured. It is | | | | |
| mandated if UE supports NR CGI reporting when NE- | | | | |
| DC is configured. | | | | |
| gNB-ID-LengthReporting-NRDC-r17 | E | Y | o | o |
| Indicates whether the UE supports acquisition | | | | |
| and reporting of gNB ID length from a neighbouring | | | | |
| intra-frequency or inter-frequency NR cell by reading | | | | |
| the SI of the neighbouring cell and reporting the | | | | |
| acquired gNB ID length to the network as specified in | | | | |
| TS 38.331 when the NR-DC is configured wherein MN | | | | |
| and SN have different DRX cycles, or on-duration | | | | |
| configured by MN does not contain on-duration | | | | |
| configured by SN if the DRX cycles are the same. It is | | | | |
| mandated if UE supports NR CGI reporting when NR- | | | | |
| DC is configured. | | | | |
| nr-AutonomousGaps-ENDC-r16 | E | o | o | es |
| Defines whether the UE supports, upon | | | | |
| configuration of useAutonomousGaps by the network, | | | | |
| acquisition of relevant information from a neighbouring | | | | |
| NR cell by reading the SI of the neighbouring cell using | | | | |
| autonomous gap and reporting the acquired information | | | | |
| to the network as specified in TS 38.331 when | | | | |
| (NG)EN-DC is configured. If this parameter is | | | | |
| indicated for FR1 and FR2 differently, each indication | | | | |
| corresponds to the frequency range of measured target | | | | |
| cell. | | | | |
| nr-AutonomousGaps-NEDC-r16 | E | o | o | es |
| Defines whether the UE supports, upon | | | | |
| configuration of useAutonomousGaps by the network, | | | | |
| acquisition of relevant information from a neighbouring | | | | |
| NR cell by reading the SI of the neighbouring cell using | | | | |
| autonomous gap and reporting the acquired information | | | | |
| to the network as specified in TS 38.331 when NE-DC | | | | |
| is configured. If this parameter is indicated for FR1 and | | | | |
| FR2 differently, each indication corresponds to the | | | | |
| frequency range of measured target cell. | | | | |
| nr-AutonomousGaps-NRDC-r16 | E | o | o | es |
| Defines whether the UE supports, upon | | | | |
| configuration of useAutonomousGaps by the network, | | | | |
| acquisition of relevant information from a neighbouring | | | | |
| NR cell by reading the SI of the neighbouring cell using | | | | |
| autonomous gap and reporting the acquired information | | | | |
| to the network as specified in TS 38.331 when NR-DC | | | | |
| is configured. If this parameter is indicated for FR1 and | | | | |
| FR2 differently, each indication corresponds to the | | | | |
| frequency range of measured target cell. | | | | |
| nr-CGI-Reporting | E | es | o | o |
| Defines whether the UE supports acquisition | | | | |
| of relevant CGI-information from a neighbouring intra- | | | | |
| frequency or inter-frequency NR cell by reading the SI | | | | |
| of the neighbouring cell and reporting the acquired | | | | |
| information to the network as specified in TS 38.331 | | | | |
| when (NG)EN-DC and NE-DC are not configured or, | | | | |
| when consistent DRX is configured in NR-DC. The | | | | |
| consistent DRX configuration implies that MN and SN | | | | |
| have the same DRX cycle and on-duration configured | | | | |
| by MN completely contains on-duration configured by | | | | |
| SN. It is optional for RedCap UEs. | | | | |
| nr-CGI-Reporting-ENDC | E | es | o | o |
| Defines whether the UE supports acquisition | | | | |
| of relevant CGI-information from a neighbouring intra- | | | | |
| frequency or inter-frequency NR cell by reading the SI | | | | |
| of the neighbouring cell and reporting the acquired | | | | |
| information to the network as specified in TS 38.331 | | | | |
| when the (NG)EN-DC is configured. | | | | |
| nr-CGI-Reporting-NEDC | E | es | o | o |
| Defines whether the UE supports acquisition | | | | |
| of relevant information from a neighbouring intra- | | | | |
| frequency or inter-frequency NR cell by reading the SI | | | | |
| of the neighbouring cell and reporting the acquired | | | | |
| information to the network as specified in TS 38.331 | | | | |
| when the NE-DC is configured. | | | | |
| nr-CGI-Reporting-NPN-r16 | E | Y | o | o |
| Defines whether the UE supports acquisition | | | | |
| of NPN-relevant CGI-information from a neighbouring | | | | |
| intra-frequency or inter-frequency NR NPN cell by | | | | |
| reading the SI of the neighbouring cell and reporting the | | | | |
| acquired information to the network as specified in TS | | | | |
| 38.331. If UE supports NPN, UE shall report this | | | | |
| capability. It is optional for RedCap UEs. | | | | |
| nr-CGI-Reporting-NRDC | E | es | o | o |
| Defines whether the UE supports acquisition | | | | |
| of relevant information from a neighbouring intra- | | | | |
| frequency or inter-frequency NR cell by reading the SI | | | | |
| of the neighbouring cell and reporting the acquired | | | | |
| information to the network as specified in TS 38.331 | | | | |
| when the NR-DC is configured wherein MN and SN | | | | |
| have different DRX cycles, or on-duration configured | | | | |
| by MN does not contain on-duration configured by SN | | | | |
| if the DRX cycles are the same. | | | | |

In step 1e-15, the base station 1e-02 may transmit a predetermined RRC message including measurement configuration information (measConfig) to the UE 1e-01. The predetermined RRC message may include an RRC reconfiguration message (RRCReconfiguration) or an RRC resumption message (RRCResume). The measurement configuration information contained in the predetermined RRC message may include at least one of the following:
measObjectToAddModList
   The measObjectToAddModList may include a MeasObjectToAddModList information element (hereinafter referred to as an IE).
   The MeasObjectToAddModList IE may constitute one or multiple MeasObjectToAddMod.
   Each MeasObjectToAddMod may include a measObjectId, and may include a measObject corresponding to the measObjectId.
   The measObject may include one of a measurement object regarding NR (i.e., measObjectNR) and a measurement object regarding EUTRA (i.e., measObjectEUTRA).
reportConfigToAddModList
   The reportConfigToAddModList may include a ReportConfigToAddModList IE.
   The ReportConfigToAddModList IE may constitute one or multiple ReportConfigToAddMod.
   Each ReportConfigToAddMod may include a reportConfigId and a reportConfig corresponding to the reportConfigId.
   The reportConfig may include one of a reporting configuration regarding NR (i.e., reportConfigNR) and a reporting configuration regarding InterRAT (i.e., reportConfigInterRAT).
In this embodiment, there may be at least one ReportConfigId in which reportType is set to reportCGI in reportConfigNR. The reportCGI may include a reportCGI and configure at least one from among one or multiple cellForWhichToReportCGI and an useAutonomousGaps indicators. Specifically, cellForWhichToReportCGI may include one or multiple PhysCellID (or PhysCellIdRange). The useAutonomousGaps indicator may be an indicator indicating whether the UE is able to acquire system information from an NR neighbor cell by using autonomous gaps.
measIdToAddModList
   measIdToAddModList may include a MeasIdToAddModList IE.
   The MeasIdToAddModList IE may constitute one or multiple MeasIdToAddMods.

Each MeasIdToAddMod may include a measId, a measObjectId and a reportConfigId corresponding to the measId.

In step 1e-20, the UE 1e-01 may apply measurement configuration information received from the base station 1e-02. For example, if the reportType is set to reportCGI in the reportConfig associated with this measId, the UE may operate the T321 timer by differently configuring the T321 timer value according to which RAT (E-UTRA or NR) is considered by the measObject associated with the corresponding measId, which frequency band is considered (FR1 or FR2) if NR is considered, and whether the reportConfig associated with the corresponding measId includes useAutonomousGaps, or according to the RedCap UE with 1 Rx branch, or according to the frequency domain (FRI or FR2).

In step 1e-25, the UE 1e-01 may perform measurements by applying the measurement configuration information received in step 1e-20.

In step 1e-30, the UE 1e-01 may determine whether a measurement report is triggered. For example, in case that, with regard to each measId included in the measIdList belonging to VarMeasConfig, reportConfig having a reportType set to reportCGI is included, and in case that a cell having a physical cell identity matching with the value of cellForWhichToReportCGI included in reportConfig belonging to VarMeasConfig is detected in associated measObject, the UE may determine that the corresponding cell is applicable to measurement report triggering (consider the cell detected on the associated measObject which a physical cell identity matching the value of the cellForWhichToReportCGI included in the corresponding reportConfig within the VarMeasConfig to be applicable). For reference, in order for the UE to detect a cell, at least the corresponding cell may transmit an SSB and, in case that the UE receives the SSR, and in case that a predetermined condition is satisfied, the UE may detect the corresponding cell. Sections 4.2.2.3 and 4.2.2.4 in TS 38.133 may be referenced for details. In case that the reportType is set to reportCGI, the UE may stop the T321 timer in case that the UE has acquired system information block (SIB) 1 with regard to the requested cell, or in case of detecting no SIB1 transmitted from the requested cell. Further, the UE 1e-01 may include a measurement report entry in the VarMeasReportList with regard to the corresponding measId. The UE 1e-01 may configure numberOfReportsSent, which is defined in VarMeasReportList, as 0, and perform a measurement reporting procedure. In case that the T321 timer expires with regard to the corresponding measId, the UE 1e-01 may include a measurement report entry in VarMeasReportList with regard to the corresponding measId. In addition, the UE 1e-01 may configure numberOfReportsSent defined in VarMeasReportList to 0, and perform a measurement reporting procedure.

In step 1e-35, the UE 1e-01 may transmit a measurement report (MeasurementReport) message to the base station 1e-02. The UE 1e-01 may configure a measResult in the measurement report message with regard to each measId in which the measurement reporting procedure is triggered. For example, a measurement identity that triggered a measurement report may be set to measId. If there is at least one applicable neighboring cell to report, the UE 1e-01 may perform the following operation to transmit the measurement report message (MeasurementReport message) including cgi-InfoNR to the base station 1e-02 if the cell indicated by cellForWhichReportCGI is an NR cell. Obviously, the following example is not limiting.
In case that the UE 1e-01 has acquired plmn-IdentityInfoList of cgi-Info from the NR cell indicated in cellForWhichReportCGI (if plmn-IdentityInfoList of the cgi-Info for the concerned cell has been obtained), the UE 1e-01:
   may include plmn-Identity InfoList including plmn-IdentityList, trackingAreaCode (if possible), ranac (if possible), cellIdentity, and/or cellReservedForOperatorUse, with regard to each entry of plmn-IdentityInfoList, in cgi-InfoNR
   if possible, may include frequencyBandList in cgi-InfoNR
   with regard to each PLMN-IdentityInfo in plmn-IdentityInfoList, if gNB-ID-Length is being broadcast, may include gNB-ID-Length in cgi-InfoNR
In case that npn-IdentityInfoList of cgi-info is acquired from the NR cell indicated in cellForWhichReportCGI (if npn-Identity InfoList of the cgi-Info for the concerned cell has been obtained), the UE 1e-01:
   may include npn-IdentityInfoList including npn-IdentityList, trackingAreaCode (if available), ranac (if available), cellIdentity, and/or cellReservedForOperatorUse, with regard to each entry of the npn-IdentityList, in cgi-InfoNR
   with regard to each NPN-IdentityInfo included in NPN-IdentityInfoList, if gNB-ID-Length is broadcast, may include gNB-ID-Length in cgi-InfoNR.
   if possible, may include cellReservedForOtherUse in cgi-InfoNR
In case that SIB 1 is not broadcast through the master information block (MIB) in the NR cell indicated by cellForWhichReportCGI (else if MIB indicates the SIBI is not broadcast), the UE 1e-01 may include ssb-SubCarrierOffset acquired from the MIB of the cell and noSIB1 including pdcch-ConfigSIB1, in cgi-InfoNR.

FIG. 1F illustrates a procedure in which a UE in an RRC connected mode (RRC_CONNECTED) in a wireless communication system transmits an indicator indicating an HSDN cell to a base station for the sake of ANR through a measurement report message according to an embodiment of the disclosure.

Referring to FIG. 1F, the UE 1f-01 may be in an RRC connected mode (RRC_CONNECTED) by establishing an RRC connection (1f-05) with the base station 1f-02.

In step 1f-10, the UE 1f-01 may transmit a UE capability information message (for example, UECapabilityInformation) to the base station 1f-02 through a UE capability transfer procedure. At least one of the capability parameters of the above-described embodiment (FIG. 1E) may be included in the UE capability information message. Additionally, the disclosure proposes that the following capability parameters be included in the message according to at least one of the following options. Obviously, the following example is not limiting.
Option 1: in case that the following UE capability can be supported only in case that (N)GEN-DC, NE-DC, and NR-DC are not configured (for example, in case of operating based on NR SA with carrier aggregation or NR SA without carrier aggregation):
   nr-CGI-Reporting-HSDN-r19: may be a parameter that defines the capability of reading system information of a neighbor cell according to TS 38.331, (acquiring) HSDN cell information from an NR HSDN cell (e.g., intra-frequency NR HSDN cell) using the same carrier frequency as the serving cell or from an NR HSDN cell (e.g., inter-frequency NR HSDN cell) using a different carrier frequency from the serving cell, and reporting the same to the base station. This parameter defines whether the UE supports acquisition of HSDN cell information from a neighbouring intra-frequency or inter-frequency NR HSDN cell by reading the SI of the neighbouring cell and reporting the acquired information to the network as specified in TS 38.331. For reference, the UE capability may be defined separately according to whether the same is related to NPN or not (e.g., non-NPN or public land mobile network (PLMN)).
Option 2: In case that whether the following UE capability is supported is distinguished according to multi-RAT dual connectivity (MR-DC)
   nr-CGI-Reporting-HSDN-r19: may be a parameter that defines the capability of reading system information of a neighbor cell according to TS 38.331, (acquiring) HSDN cell information from an NR HSDN cell (e.g., intra-frequency NR HSDN cell) using the same carrier frequency as the serving cell or from an NR HSDN cell (e.g., inter-frequency NR HSDN cell) using a different carrier frequency from the serving cell, and reporting the same to the base station, in case that (NG)EN-DC and NE-DC are not configured, or in case that consistent discontinuous reception (DRX) is configured in NR-DC. This parameter defines whether the UE supports acquisition of HSDN cell information from a neighbouring intra-frequency or inter-frequency NR HSDN cell by reading the SI of the neighbouring cell and reporting the acquired information to the network as specified in TS 38.331 when (NG)EN-DC and NE-DC are not configured or, when consistent DRX is configured in NR-DC. The consistent DRX configuration may mean that the master node (MN) and the secondary node (SN) have the same DRX cycle, and the on-duration configured by the MN fully includes the on-duration configured by the SN. Note that the consistent DRX configuration implies that MN and SN have the same DRX cycle and on-duration configured by MN completely contains on-duration configured by SN.

For reference, the UE capability may be defined separately according to whether the same is related to NPN or not (e.g., non-NPN or PLMN).
nr-CGI-Reporting-HSDN-ENDC-r19: may be a parameter that defines the capability of reading system information of a neighbor cell according to TS 38.331, (acquiring) HSDN cell information from an NR HSDN cell (e.g., intra-frequency NR HSDN cell) using the same carrier frequency as the serving cell or from an NR HSDN cell (e.g., inter-frequency NR HSDN cell) using a different carrier frequency from the serving cell, and reporting the same to the base station, in case that (NG)EN-DC is configured. This parameter defines whether the UE supports acquisition of HSDN cell information from a neighbouring intra-frequency or inter-frequency NR HSDN cell by reading the SI of the neighbouring cell and reporting the acquired information to the network as specified in TS 38.331 when (NG)EN-DC are configured. For reference, the UE capability may be defined separately according to whether the same is related to NPN or not (e.g., non-NPN or PLMN).
nr-CGI-Reporting-HSDN-NRDC-r19: may be a parameter that defines the capability of reading system information of a neighbor cell according to TS 38.331, (acquiring) HSDN cell information from an NR HSDN cell (e.g., intra-frequency NR HSDN cell) using the same carrier frequency as the serving cell or from an NR HSDN cell (e.g., inter-frequency NR HSDN cell) using a different carrier frequency from the serving cell, and reporting the same to the base station, in case that EN-DC is configured. This parameter defines whether the UE supports acquisition of HSDN cell information from a neighbouring intra-frequency or inter-frequency NR HSDN cell by reading the SI of the neighbouring cell and reporting the acquired information to the network as specified in TS 38.331 when the NE-DC is configured. For reference, the UE capability may be defined separately according to whether the same is related to NPN or not (e.g., non-NPN or PLMN).
nr-CGI-Reporting-HSDN-NRDC-r19: may be a parameter that defines the capability of reading system information of a neighbor cell according to TS 38.331, (acquiring) HSDN cell information from an NR HSDN cell (e.g., intra-frequency NR HSDN cell) using the same carrier frequency as the serving cell or from an NR HSDN cell (e.g., inter-frequency NR HSDN cell) using a different carrier frequency from the serving cell, and reporting the same to the base station, in case that, while NR-DC is configured, the MN and SN have different DRX cycles, or in case that the MN and SN have the same DRX cycle, but the on-duration configured by the MN does not include the on-duration configured by the SN. This parameter defines whether the UE supports acquisition of HSDN cell information from a neighbouring intra-frequency or inter-frequency NR HSDN cell by reading the SI of the neighbouring cell and reporting the acquired information to the network as specified in TS 38.331 when the NR-DC is configured wherein MN and SN have different DRX cycles, or on-duration configured by MN does not contain on-duration configured by SN if the DRX cycles are the same. For reference, the UE capability may be defined separately according to whether the same is related to NPN or not (e.g., non-NPN or PLMN).
Option 3: In the case of distinguishing application of the following capability parameters according to whether the UE capability parameters described above with reference to FIG. 1E are supported:
nr-CGI-Reporting-HSDN-r19: may be a parameter that defines the capability of reading system information of a neighbor cell according to TS 38.331, (acquiring) HSDN cell information from an NR HSDN cell (e.g., intra-frequency NR HSDN cell) using the same carrier frequency as the serving cell or from an NR HSDN cell (e.g., inter-frequency NR HSDN cell) using a different carrier frequency from the serving cell, and reporting the same to the base station. This parameter defines whether the UE supports acquisition of HSDN cell information from a neighbouring intra-frequency or inter-frequency NR HSDN cell by reading the SI of the neighbouring cell and reporting the acquired information to the network as specified in TS 38.331.

Additionally,
a UE supporting nr-CGI-Reporting and nr-CGI-Reporting-HSDN-r19 may support nr-CGI-Reporting-HSDN-r19 according to constraint conditions of nr-CGI-Reporting in case that (NG)EN-DC and NE-DC are not configured, or in case that a consistent DRX is configured in NR-DC.
a UE supporting nr-CGI-Reporting-ENDC and nr-CGI-Reporting-HSDN-r19 may support nr-CGI-Reporting-HSDN-r19 according to constraint conditions of nr-CGI-Reporting-ENDC in case that (NG)EN-DC is configured.
a UE supporting nr-CGI-Reporting-NEDC and nr-CGI-Reporting-HSDN-r19 may support nr-CGI-Reporting-HSDN-r19 according to constraint conditions of nr-CGI-Reporting-NEDC in case that NE-DC is configured.
a UE supporting r-CGI-Reporting-NRDC and nr-CGI-Reporting-HSDN-r19 may support nr-CGI-Reporting-HSDN-r19 according to constraint conditions of nr-CGI-Reporting-NRDC in case that the MN and SN have different DRX cycles while NR-DC is configured, or in case that the MN and SN have the same DRX cycle but the on-duration configured by the MN does not include the on-duration configured by the SN.

In step 1f-13, NE-DC or NR-DC may be configured for the UE 1f-01. In case that the base station 1f-02 is an NR base station and the base station 1f-03 is an LTE base station, the UE 1f-01 may operate based on NE-DC. In case that the base station 1f-02 is an NR base station and the base station 1f-03 is an NR base station, the UE 1f-01 may operate based on NR-DC. For reference, the base station 1f-02 is the MN, and the base station 1f-03 is the SN.

In step 1f-14, the NR base station 1f-03 may transmit a CG-Config message to the NR base station 1f-02. The CG-Config message may include reportCGI-RequestNR. The reportCGI-RequestNR may include requested cell information (for example, requestedCellInfo), and the requestedCellInfo may include at least one of the following. Obviously, the following examples are not limiting.
ssbFrequency: an absolute radio frequency channel number-ValueNR (hereinafter, referred to as (ARFCN-ValueNR) value regarding NR may be included as the ssb frequency of the requested cell.
cellForWhichToReportCGI: a physical cell identity (PhysCellId) value may be included for a CGI report request regarding a specific cell.

In step 1f-15, the base station 1f-02 may transmit a predetermined RRC message including measurement configuration information (measConfig) to the UE 1f-01. The predetermined RRC message may include an RRC reconfiguration message (RRCReconfiguration) or an RRC connection resumption message (RRCResume). In this case, the above-described embodiment 1e may be followed.

In step 1f-20, the UE 1f-01 may apply the measurement configuration information received from the base station 1f-02. In this case, the above-described embodiment 1e may be followed.

In step 1f-25, the UE 1f-01 may perform measurement by applying the measurement configuration information received in step 1f-20.

In step 1f-30, the UE 1f-01 may determine whether a measurement report is triggered. This may follow the above-described embodiment 1e.

In step 1f-35, the UE 1f-01 may transmit a measurement report message (e.g., a MeasurementReport message) to the base station 1f-02. The UE 1f-01 may configure a measResult in a measurement report message with regard to each measId that triggered the measurement reporting procedure. For example, the UE 1f-01 may set the measurement identity that triggered a measurement report as measId. If there is at least one applicable neighboring cell to report, the UE 1f-01 may transmit a measurement report message (for example, MeasurementReport message) including cgi-InfoNR to the base station 1f-02 by performing at least one of the following operations if the cell indicated by cellForWhichReportCGI is an NR cell. Obviously, the following examples are not limiting. For reference, the UE of the disclosure may successively perform the detailed operations described above in each operation.
Operation 1: in case that cgi-Info's plmn-IdentityInfoList and/or npn-Identity InfoList are acquired from the indicated cell, the measurement report message may include hsdn-Cell. More specifically, the UE 1f-01:
   in case that plmn-IdentityInfoList of cgi-Info is acquired from the NR cell indicated by cellForWhichReportCGI (if plmn-IdentityInfoList of the cgi-Info for the concerned cell has been obtained),
      may include plmn-IdentityInfoList including plmn-IdentityList, trackingAreaCode (if possible), ranac (if possible), cellIdentity, and/or cellReservedForOperatorUse, with regard to each entry of plmn-IdentityInfoList, in cgi-InfoNR (include the plmn-IdentityInfoList including plmn-IdentityList, trackingAreaCode (if available), trackingAreaList (if available), ranac (if available), cellIdentity and cellReservedForOperatorUse for each entry of the plmn-IdentityInfoList).
      may include frequencyBandList in cgi-InfoNR, if possible (include frequencyBandList if available).
      with regard to each PLMN-IdentityInfo in plmn-IdentityInfoList, if gNB-ID-Length is broadcast, this may be included in cgi-InfoNR (for each PLMN-IdentityInfo in plmn-Identity InfoList, if the gNB-ID-Length is broadcast, include gNB-ID-Length).
      if the UE 1f-01 that is able to acquire HSDN cell information and report the same to the base station according to step 1f-10 has acquired hsdn-Cell from the indicated cell, cgi-InfoNR may include hsdn-Cell.
      in case that npn-IdentityInfoList of cgi-info is acquired from the NR cell indicated in cellForWhichReportCGI (if npn-Identity InfoList of the cgi-Info for the concerned cell has been obtained), the UE 1f-01:
      with regard to each entry of npn-IdentityList, npn-IdentityInfoList including npn-IdentityList, trackingAreaCode (if possible), ranac (if possible), cellIdentity, and cellReservedForOperatorUse may be included in cgi-InfoNR (include the npn-IdentityInfoList including npn-IdentityList, trackingAreaCode, ranac (if available), cellIdentity and cellReservedForOperatorUse for each entry of the npn-IdentityInfoList).
      with regard to each NPN-IdentityInfo included in NPN-IdentityInfoList, if gNB-ID-Length is broadcast, gNB-ID-Length may be included in cgi-InfoNR (for each NPN-Identity Info in NPN-Identity InfoList, if the gNB-ID-Length is broadcast, include gNB-ID-Length).
      if possible, cellReservedForOtherUse may be included in cgi-InfoNR (include cellReservedForOtherUse if available).
      if the UE 1f-01 capable of acquiring HSDN cell information according to step 1f-10 and reporting the same to the base station has acquired hsdn-Cell from the indicated cell, hsdn-Cell may be included in cgi-InfoNR. For reference, if cgi-InfoNR already includes hsdn-Cell, hsdn-Cell may not be redundantly included.
   inn case that it is indicated that SIB1 is not broadcast through the MIB in the NR cell indicated by cellForWhichReportCGI (else if MIB indicates the SIB1 is not broadcast), noSIB1 including pdcch-ConfigSIB1 and ssb-SubCarrierOffset acquired from the MIB of the cell may be included in cgi-InfoNR.
Operation 2: in case that hsdn-Cell has been acquired regardless of whether plmn-IdentityInfoList and/or npn-IdentityInfoList of cgi-Info have been acquired from the indicated cell, cgi-InfoNR may include the following:
   in case that plmn-IdentityInfoList of cgi-Info has been acquired from the NR cell indicated by cellForWhichReportCGI (if plmn-IdentityInfoList of the cgi-Info for the concerned cell has been obtained),
      with regard to each entry of plmn-IdentityInfoList, plmn-IdentityInfoList including plmn-IdentityList, trackingAreaCode (if possible), ranac (if possible), cellIdentity, and/or cellReservedForOperatorUse may be included in cgi-InfoNR (include the plmn-Identity InfoList including plmn-IdentityList, trackingAreaCode (if available), trackingAreaList (if available), ranac (if available), cellIdentity and cellReservedForOperatorUse for each entry of the plmn-IdentityInfoList).
      if possible, frequencyBandList may be included in cgi-InfoNR (include frequencyBandList if available).
      with regard to each PLMN-IdentityInfo in plmn-IdentityInfoList, if gNB-ID-Length is broadcast, the gNB-ID-Length may be included in cgi-InfoNR (for each PLMN-Identity Info in plmn-Identity InfoList, if the gNB-ID-Length is broadcast, include gNB-ID-Length).
      if the UE 1f-01 capable of acquiring HSDN cell information and reporting the same to the base station according to step 1f-10 acquires hsdn-Cell from the indicated cell, cgi-InfoNR may include hsdn-Cell.
   in case that npn-IdentityInfoList of cgi-Info is acquired from the NE cell indicated by cellForWhichReportCGI (if npn-IdentityInfoList of the cgi-Info for the concerned cell has been obtained),
      with regard to each entry of npn-IdentityList, npn-IdentityInfoList including npn-IdentityList, trackingAreaCode (if possible), ranac (if possible), cellIdentity, and/or cellReservedForOperatorUse may be included in cgi-InfoNR (include the npn-IdentityInfoList including npn-IdentityList, trackingAreaCode, ranac (if available), cellIdentity and cellReservedForOperatorUse for each entry of the npn-IdentityInfoList).
      with regard to each NPN-IdentityInfo included in NPN-Identity InfoList, if gNB-ID-Length is broadcast, gNB-ID-Length may be included in cgi-InfoNR (for each NPN-IdentityInfo in NPN-Identity InfoList, if the gNB-ID-Length is broadcast, include gNB-ID-Length).
      if possible, cellReservedForOtherUse may be included in cgi-InfoNR include cellReservedForOtherUse if available).
   if the UE 1f-01 capable of acquiring HSDN cell information and reporting the same to the base station according to step 1f-10 has acquired hsdn-Cell from the indicated cell, cgi-InfoNR may include hsdn-Cell. For reference, if cgi-InfoNR has already included hsdn-Cell, hsdn-Cell may not be redundantly included.
   in case that it is indicated that SIBI is not broadcast through the MIB in the NR cell indicated by cellForWhichReportCGI (else if MIB indicates the SIBI is not broadcast), the UE 1f-01 may include noSIB1 including pdcch-ConfigSIB1 and ssb-SubcarrierOffset acquired from the MIB of the cell in cgi-InfoNR (include the noSIB1 including the ssb-SubcarrierOffset and pdcch-ConfigSIB1 obtained from MIB of the concerned cell).

For reference, operation 1 and operation 2 above may be performed only in case that SIB1 is broadcast. For example, the UE 1f-01 may not perform the following detailed operations in case that operation 1 or operation 2 above has been performed.
In case that it is indicated that SIB1 is not broadcast through the MIB in the NR cell indicated by cellForWhichReportCGI, the UE 1f-01 may include noSIB1 including pdcch-ConfigSIB1 and ssb-SubCarrierOffset acquired from the MIB of the cell, in cgi-InfoNR.

In step 1f-40, the NR base station 1f-02 may transmit CG-ConfigInfo to the NR base station 1f-03. CG-ConfigInfo may include measResultReportCGI. The measResultReportCGI may include at least one of the following parameters:
ssbFrequency: an ARFCN-ValueNR value regarding NR may be included as ssb frequency. The ssb frequency may have the same value as that in step 1f-14.
cellForWhichToReportCGI: a PhysCellId value, which is a physical cell identifier regarding a CGI reporting regarding a specific cell, may be included.
cgi-Info: CGI-InfoNR which indicates CGI information regarding PhysCellId in the ssb frequency may be included. The CGI-InfoNR may include hsdn-Cell information. Obviously, in case that the NR base station 1f-02 cannot transfer hsdn-Cell information to the NR base station 1f-03 in reportCGI configured by the SN in NR-DC, hsdn-Cell information may not be included in cgi-Info.

FIG. 1G illustrates a diagram depicting a procedure in which a UE in an RRC connected mode (RRC_CONNECTED) in a wireless communication system transmits an indicator indicating an HSDN cell to a base station for the sake of ANR through a measurement report message according to an embodiment of the disclosure.

Referring to FIG. 1G, the UE 1g-01 may be in an RRC connected mode (RRC_CONNECTED) by configuring an RRC connection (1g-05) with the base station 1g-02.

In step 1g-10, the UE 1g-01 may transmit a UE capability information message (e.g., UECapabilityInformation) to the base station 1g-02 through a UE capability transmission procedure (e.g., UE capability transfer procedure). The UE capability information message may include at least one of the capability parameters of the above-described embodiments (FIG. 1E and FIG. 1F). Additionally, the disclosure proposes that the following capability parameters be included in the message according to at least one of the following options. Obviously, the following examples are not limiting.
Option 1: in case that the following UE capability can be supported only in case that (NE) EN-DC, NE-DC, and NR-DC are not configured (for example, in case of operating based on NR SA with carrier aggregation or NR SA without carrier aggregation):
   eutra-CGI-Reporting-HSDN-r19: may be a parameter that defines the capability of reading system information of a neighbor cell according to TS 38.331, (acquiring) HSDN cell information from an E-UTRA HSDN cell, and reporting the same to the base station. This parameter defines whether the UE supports acquisition of HSDN cell information from a neighbouring E-UTRA HSDN cell by reading the SI of the neighbouring cell and reporting the acquired information to the network as specified in TS 38.331. For reference, the UE capability may be defined separately according to whether the same is related to NPN or not (e.g., non-NPN or PLMN).
Option 2: In case that whether the following UE capability is supported is distinguished according to MR-DC
   eutra-CGI-Reporting-HSDN-r19: may be a parameter that defines the capability of reading system information of a neighbor cell according to TS 38.331, (acquiring) HSDN cell information from an E-UTRA HSDN cell, and reporting the same to the base station, in case that (NG)EN-DC and NE-DC are not configured, or in case that consistent DRX is configured in NR-DC. This parameter defines whether the UE supports acquisition of HSDN cell information from a neighbouring E-UTRA HSDN cell by reading the SI of the neighbouring cell and reporting the acquired information to the network as specified in TS 38.331 when (NG)EN-DC and NE-DC are not configured or, when consistent DRX is configured in NR-DC. The consistent DRX configuration may mean that the MN and the SN have the same DRX cycle, and the on-duration configured by the MN fully includes the on-duration configured by the SN. Note that the consistent DRX configuration implies that MN and SN have the same DRX cycle and on-duration configured by MN completely contains on-duration configured by SN. For reference, the UE capability may be defined separately according to whether the same is related to NPN or not (e.g., non-NPN or PLMN).
   eutra-CGI-Reporting-HSDN-NEDC-r19: may be a parameter that defines the capability of reading system information of a neighbor cell according to TS 38.331, (acquiring) HSDN cell information from an E-UTRA HSDN cell, and reporting the same to the base station, in case that EN-DC is configured. This parameter defines whether the UE supports acquisition of HSDN cell information from a neighbouring E-UTRA HSDN cell by reading the SI of the neighbouring cell and reporting the acquired information to the network as specified in TS 38.331 when the NE-DC is configured. For reference, the UE capability may be defined separately according to whether the same is related to NPN or not (e.g., non-NPN or PLMN).
   eutra-CGI-Reporting-HSDN-NRDC-r19: may be a parameter that defines the capability of reading system information of a neighbor cell according to TS 38.331, (acquiring) HSDN cell information from an E-UTRA HSDN cell, and reporting the same to the base station, in case that the MN and SN have different DRX cycles while NR-DC is configured, or in case that the MN and SN have the same DRX cycle, but the on-duration configured by the MN does not include the on-duration configured by the SN. This parameter defines whether the UE supports acquisition of HSDN cell information from a neighbouring E-UTRA HSDN cell by reading the SI of the neighbouring cell and reporting the acquired information to the network as specified in TS 38.331 when the NR-DC is configured wherein MN and SN have different DRX cycles, or on-duration configured by MN does not contain on-duration configured by SN if the DRX cycles are the same. For reference, the UE capability may be defined separately according to whether the same is related to NPN or not (e.g., non-NPN or PLMN).
Option 3: In the case of distinguishing application of the following capability parameters according to whether the UE capability parameters described above with reference to FIG. 1E are supported:
   eutra-CGI-Reporting-HSDN-r19: may be a parameter that defines the capability of reading system information of a neighbor cell according to TS 38.331, (acquiring) HSDN cell information from an E-UTRA HSDN cell, and reporting the same to the base station. This parameter defines whether the UE supports acquisition of HSDN cell information from a neighbouring E-UTRA HSDN cell by reading the SI of the neighbouring cell and reporting the acquired information to the network as specified in TS 38.331. Additionally,
      a UE supporting eutra-CGI-Reporting and eutra-CGI-Reporting-HSDN-r19 may support eutra-CGI-Reporting-HSDN-r19 according to constraint conditions of eutra-CGI-Reporting in case that (NG)EN-DC and NE-DC are not configured, or in case that a consistent DRX is configured in NR-DC.
      a UE supporting eutra-CGI-Reporting-NEDC and eutra-CGI-Reporting-HSDN-r19 may support eutra-CGI-Reporting-HSDN-r19 according to constraint conditions of eutra-CGI-Reporting-NEDC in case that EN-DC is configured.
      a UE supporting eutra-CGI-Reporting-NRDC and eutra-CGI-Reporting-HSDN-r19 may support eutra-CGI-Reporting-HSDN-r19 according to constraint conditions of eutra-CGI-Reporting-NRDC in case that the MN and SN have different DRX cycles while NR-DC is configured, or in case that the MN and SN have the same DRX cycle but the on-duration configured by the MN does not include the on-duration configured by the SN.

In step 1g-13, NE-DC or NR-DC may be configured for the UE 1g-01. In case that the base station 1g-02 is an NR base station and the base station 1g-03 is an LTE base station, the UE 1g-01 may operate based on NE-DC. In case that the base station 1g-02 is an NR base station and the base station 1g-03 is an LTE base station, the UE 1g-01 may operate based on NE-DC. For reference, the base station 1g-02 is the MN, and the base station 1g-03 is the SN.

In step 1g-14, the LTE (or E-UTRA) base station 1g-03 may transmit a CG-Config message to the NR base station 1g-02. The CG-Config message may include reportCGI-RequestEUTRA. The reportCGI-RequestEUTRA may include requested cell information (for example, requestedCellInfoEUTRA), and the requestedCellInfoEUTRA may include at least one of the following. Obviously, the following examples are not limiting.
eutraFrequency: an absolute radio frequency channel number-ValueEUTRA (hereinafter, referred to as ARFCN-ValueEUTRA) value regarding EUTRA may be included as the requested cell's EUTRA frequency.
cellForWhichToReportCGI-CGI: an EUTRA-PhysCellId value, which is an EUTRA physical cell identifier, may be included to request CGI reporting regarding a specific cell.

In step 1g-15, the base station 1g-02 may transmit a predetermined RRC message including measurement configuration information (measConfig) to the UE 1g-01. The predetermined RRC message may include an RRC connection reconfiguration message (RRCReconfiguration) or an RRC connection resumption message (RRCResume). In this case, the above-described embodiment (1E) may be followed. However, in this embodiment, there may be at least one ReportConfigId, the reportType of which is set to reportCGI, in reportConfigInterRAT. The reportCGI may include ReportCGI, and at least one from among or multiple cellForWhichToReportCGI and useAutonomousGaps indicators may be configured in the ReportCGI. Specifically, cellsForWhichToReportCGI may include one or multiple EUTRA-PhysCellId(s) (or EUTRA-PhysCellIdRange). The useAutonomousGaps indicator may be an indicator indicating whether the UE is able to acquire system information from an EUTRA neighbor cell by using autonomous gaps.

In step 1g-20, the UE 1g-01 may apply measurement configuration information received from the base station 1g-02. In this case, the above-described embodiment (1E) may be followed.

In step 1g-25, the UE 1g-01 may perform measurement by applying the measurement configuration information received in step 1g-20.

In step 1g-30, the UE 1g-01 may determine whether a measurement report is triggered. This may follow the above-described embodiment (1E).

In step 1g-35, the UE 1g-01 may transmit a measurement report message (for example, MeasurementReport message) to the base station 1g-02. The UE 1g-01 may configure measResult in a measurement report message with regard to each measId that triggered the measurement reporting procedure. For example, the UE 1g-01 may set the measurement identity that triggered measurement reporting as measId. If there is at least one applicable neighboring cell to report, the UE 1g-01 may perform at least one of the following operations if the cell indicated in cellForWhichReportCGI is an E-UTRA cell, and may transmit a measurement report message (MeasurementReport message) regarding the same to the base station 1g-02. For reference, the UE 1g-01 of the disclosure may successively perform the detailed operations described above in each operation.
Operation 1: in case that mandatory fields present in cgi-Info regarding the cell indicated by cellsForWhichToReportCGI associated with measObject are acquired (if the mandatory present fields of the cgi-Info for the cell indicated by the cellsForWhichToReportCGI in the associated measObject have been obtained), hsdn-Cell may be included in the measurement report message. More specifically, the UE 1g-01:
   In case that all mandatory fields in cgi-Info-EPC regarding the indicated cell are acquired, cgi-Info-EPC may include fields associated with EPC that is broadcast in E-UTRA system information 1 (if all mandatory fields of the cgi-Info-EPC for the concerned cell have been obtained, include in the cgi-Info-EPC the fields broadcasted in E-UTRA SystemInformationBlockType1 associated to EPC).
   In case that the UE 1g-01 has E-UTRA/5GC capability, and all mandatory fields in cgi-Info-EPC regarding the indicated cell are acquired, cgi-Info-5GC may include fields associated with 5GC that is broadcast in E-UTRA system information 1 (if UE is E-UTRA/5GC capable and all mandatory fields of the cgi-Info-5GC for the concerned cell have been obtained, include in the cgi-Info-5GC the fields broadcasted in E-UTRA SystemInformationBlockType1 associated to 5GC).
   In case that mandatory fields present in cgi-Info-EPC regarding the cell indicated in cellForWhichToReportCGI associated with measObject are acquired (if the mandatory present fields of the cgi-Info for the cell indicated by the cellForWhichToReportCGI in the associated measObject have been obtained),
      may include the freqBandIndicator
      if the cell broadcasts the multiBandInfoList, may include the multiBandInfoList
      if the cell broadcasts the freqBandIndicatorPriority, may include the freqBandIndicatorPriority
      the UE 1g-01 capable of acquiring HSDN cell information according to step 1g-10 and reporting the same to the base station may include hsdn-Cell in case that the cell broadcasts hsdn-Cell.
Operation 2: if hsdn-Cell is acquired regardless of whether mandatory fields present in cgi-Info regarding the cell indicated in cellForWhichToReportCGI associated with measObject are acquired or not, hsdn-Cell may be included in the measurement report message. More specifically, the UE 1g-01:
   In case that all mandatory fields in the cgi-Info-EPC regarding the indicated cell are acquired, cgi-Info-EPC may include fields associated with EPC that is broadcast in E-UTRA system information 1 (if all mandatory fields of the cgi-Info-EPC for the concerned cell have been obtained, include in the cgi-Info-EPC the fields broadcasted in E-UTRA SystemInformationBlockType1 associated to EPC).
   In case that the UE 1g-01 has E-UTRA/5GC capability, and all mandatory fields in cgi-Info-EPC regarding the indicated cell are acquired, cgi-Info-5GC may include fields associated with 5GC that is broadcast in E-UTRA system information 1 (if UE is E-UTRA/5GC capable and all mandatory fields of the cgi-Info-5GC for the concerned cell have been obtained, include in the cgi-Info-5GC the fields broadcasted in E-UTRA SystemInformationBlockType1 associated to 5GC).
   In case that mandatory fields present in cgi-Info-EPC regarding the cell indicated in cellForWhichToReportCGI associated with measObject are acquired (if the mandatory present fields of the cgi-Info for the cell indicated by the cellForWhichToReportCGI in the associated measObject have been obtained),
      may include the freqBandIndicator
      if the cell broadcasts the multiBandInfoList, may include the multiBandInfoList
      if the cell broadcasts the freqBandIndicatorPriority, may include the freqBandIndicatorPriority
      the UE 1g-01 capable of acquiring HSDN cell information according to step 1g-10 and reporting the same to the base station may include hsdn-Cell in case that the cell broadcasts hsdn-Cell

For example, the UE 1g-01 may include hsdn-Cell in CGI-InfoEUTRA and transmit a measurement report message including CGI-InfoEUTRA to the base station 1g-02. As another example, the UE 1g-01 may include hsdn-Cell in MeasResultEUTRA contained in a MeasResults IE and then transmit a measurement report message to the base station 1g-02. For reference, MeasResultETURA may include at least one of eutra-PhysCellId, measResult, cgi-Info, and hsdn-Cell. Specifically, MeasResultETURA may include parameters configured as follows. Obviously, the following example is not limiting.
The eutra-PhysCellId may contain an EUTRA-PhysCellId configured by the reportCGI.
measResult may contain MeasQuantityResultsEUTRA.
cgi-Info may include CGI-InfoEUTRA (refer to Table 1-2 below).
hsdn-Cell may include an indicator that may indicate “TRUE.” For example, hsdn-Cell may be expressed as “ENUMERATED {true}.” However, although a new field hsdn-Cell is defined in CGI-InfoNR, no new field can be added due to the CGI-InfoEUTRA structure (for example, referring to Table 1-2 below, the structure has no extension indicated by “ . . . ”), and thus the hsdn-Cell field may be included in MeasResultEUTRA.

TABLE 1-2

| - CGI-InfoEUTRA | |
|---|---|
| The IE CGI-InfoEUTRA indicates EUTRA cell access | |
| related information, which is re | |
| ported by the UE as part of E-UTRA report CGI procedure. | |
| CGI-InfoEUTRA information element | |
| -- ASN1START | |
| -- TAG-CGI-INFOEUTRA-START | |
| CGI-InfoEUTRA ::= | SEQUENCE { |
| cgi-info-EPC | SEQUENCE { |
| cgi-info-EPC-legacy | CellAcces |
| sRelatedInfo-EUTRA-EPC, | |
| cgi-info-EPC-list | SEQUENCE |
| (SIZE (1..maxPLMN)) OF CellAccessRelatedInfo-EUTRA-EPC | |
| OPTIONAL | |
| } | |
| OPTIONAL, | |
| cgi-info-5GC | SEQUENCE (SIZ |
| E (1..maxPLMN)) OF CellAccessRelatedInfo-EUTRA-5GC | |
| OPTIONAL, | |
| freqBandIndicator | FreqBandIndic |
| atorEUTRA, | |
| multiBandInfoList | MultiBandInfo |
| ListEUTRA | O |
| PTIONAL, | |
| freqBandIndicatorPriority | ENUMERATED {t |
| rue} | O |

```
PTIONAL
    }
    -- TAG-CGI-INFOEUTRA-STOP
    -- ASN1STOP
```

In step 1g-40, the NR base station 1g-02 may transmit CG-ConfigInfo to the E-UTRA base station 1g-03. The CG-ConfigInfo may include measResultReportCGI-EUTRA. The measResultReportCGI-EUTRA may include at least one of the following parameters:
eutraFrequency: an ARFCN-ValueEUTRA value regarding EUTRA may be included as an eutra frequency. The eutra frequency may have the same value as in step 1g-14.
cellForWhichToReportCGI-EUTRA: an EUTRA-PhysCellId value that is a physical cell identity regarding a CGI report value regarding a specific cell may be included.
cgi-InfoEUTRA: CGI-InfoEUTRA indicating CGI information regarding E-UTRAPhysCellId in the eutra frequency may be included. The CGI-InfoEUTRA may include hsdn-Cell information. Obviously, in case that the NR base station 1g-02 cannot transfer hsdn-Cell information to the E-UTRA base station 1g-03 in reportCGI configured by the SN in NE-DC, no hsdn-Cell information may be included in cgi-InfoEUTRA.

In an embodiment, a new hsdn-Cell field may be defined in the CG-ConfigInfo. For example, as described above, since a new field cannot be added due to the measResultReportCGI-EUTRA structure, the hsdn-Cell field may be included in CG-ConfigInfo as in Table 1-3 below:

TABLE 1-3

| | |
|---|---|
| CG-ConfigInfo-v1800-IEs ::= | SEQUENCE { |
| musim-GapConfigInfo-r18 | MUSIM-GapConf |

| | |
|---|---|
| ig-r17 | OPTIONAL, |

| | |
|---|---|
| musim-CapRestrictionInfo-r18 | SEQUENCE { |
| musim-CapRestriction-r18 | MUSIM-Cap |

| | |
|---|---|
| Restriction-r18 | OPTIONAL, |

| | |
|---|---|
| musim-CandidateBandList-r18 | MUSIM-Can |

| | |
|---|---|
| didateBandList-r18 | OPTIONAL |

}

OPTIONAL,

| | |
|---|---|
| scpac-ReferenceConfiguration-r18 | ReferenceConf |

| | |
|---|---|
| iguration-r18 | OPTIONAL, |

| | |
|---|---|
| subsequentCPAC-Candidates-r18 | CandidateCell |

| | |
|---|---|
| ListCPC-r17 | OPTIONAL, |

| | |
|---|---|
| nonCriticalExtension | CG-ConfigInfo |
| -v1900 | OPTIONAL |

}

| | |
|---|---|
| CG-ConfigInfo-v1900-IEs ::= | SEQUENCE { |
| hsdn-Cell-r19 | ENUMERATED {true} |

```
      OPTIONAL
  }
```

For example, the NR base station 1g-02 may include measResultReportCGI-EUTRA and hsdn-Cell in CG-ConfigInfo and transmit the same to the E-UTRA base station 1g-03. In this case, the NR base station 1g-02 cannot transmit CG-ConfigInfo containing only hsdn-Cell without measResultReportCGI-EUTRA to the E-UTRA base station 1g-03.

FIG. 1H illustrates a procedure in which a UE in an RRC connected mode (RRC_CONNECTED) in a wireless communication system transmits an indicator indicating an HSDN cell to a base station for the sake of ANR through a measurement report message according to an embodiment of the disclosure.

Referring to FIG. 1H, the UE 1h-01 may establish an RRC connection with the base station 1h-02 and thus be in an RRC connected mode (RRC_CONNECTED) (1h-05).

In step 1h-10, the UE 1h-01 may transmit a UE capability information message (for example, UECapabilityInformation) to the base station 1h-02 through a UE capability transfer procedure. The UE capability information message may include at least one of the following capability parameters. Obviously, the following examples are not limiting.
intraFreqSI-AcquisitionForHO: may be a parameter that defines the capability of reading system information of a neighbor cell by using autonomous gaps according to 3GPP technical specifications 36.331 (TS 36.331) when configuring si-RequestForHO, acquiring related information from a neighboring intra-frequency cell, and reporting the acquired information to the base station. This parameter defines whether the UE supports, upon configuration of si-RequestForHO by the network, acquisition of relevant information from a neighbouring intra-frequency cell by reading the SI of the neighbouring cell using autonomous gaps and reporting the acquired information to the network as specified in TS 36.331.
interFreqSI-AcquisitionForHO: may be a parameter that defines the capability of reading system information of a neighbor cell by using autonomous gaps according to TS 36.331 when configuring si-RequestForHO, acquiring related information from a neighboring inter-frequency, and reporting the acquired information to the base station. This parameter defines whether the UE supports, upon configuration of si-RequestForHO by the network, acquisition of relevant information from a neighbouring inter-frequency cell by reading the SI of the neighbouring cell using autonomous gaps and reporting the acquired information to the network as specified in TS 36.331.
eutra-SI-AcquisitionForHO-ENDC-r16: may be a parameter that defines the capability of reading system information of a neighbor cell by using autonomous gaps in case that (NG)EN-DC is configured according to TS 36.331 when configuring si-RequestForHO, acquiring related information from a neighboring E-UTRA cell, and reporting the acquired information to the base station. This parameter defines whether the UE supports, upon configuration of si-RequestForHO by the network, acquisition of relevant information from a neighbouring E-UTRA cell by reading the SI of the neighbouring cell using autonomous gaps and reporting the acquired information to the network as specified in TS 36.331 when the (NG)EN-DC is configured.
eutra-CGI-Reporting-ENDC: may be a parameter that defines the capability of reading system information of a neighbor cell by using autonomous gaps according to TS 36.331, acquiring related information from a neighboring E-UTRA cell, and reporting the acquired information to the base station in case that the MN and SN have different DRX cycles while (NG)EN-DC is configured, or in case that the MN and SN have the same DRX cycle but the on-duration configured by the MN does not include the on-duration configured by the SN. This parameter defines whether the UE supports acquisition of relevant information from a neighbouring E-UTRA cell by reading the SI of the neighbouring cell and reporting the acquired information to the network as specified in TS 36.331 when the (NG)EN-DC is configured where either MN and SN have different DRX cycles, or on-duration configured by MN does not contain on-duration configured by SN if their DRX cycles are same.

Additionally, in the disclosure, the message may include at least one of the following capability parameters. Obviously, the following examples are not limiting.
eutra-CGI-Reporting-HSDN: may be a parameter that defines the capability of reading system information of a neighbor cell according to TS 36.331, acquiring HSDN cell information from a neighboring E-UTRA cell, and reporting the acquired information to the base station. This parameter defines whether the UE supports acquisition of HSDN cell information from a neighbouring E-UTRA cell by reading the SI of the neighbouring cell and reporting the acquired information to the network as specified in TS 36.331. For reference, the UE capability may be defined to distinguish between capability regarding an intra-EUTRA cell and capability regarding an inter-EUTRA cell. Alternatively, si-RequestForHO may be defined to be limited to supporting the UE capability when configured by the network. The UE capability may be supported regardless of whether (NG)EN-DC is configured, or may be supported only in case that (NG)EN-DC is configured, and in case that the MN and SN do not have a consistent DRX configuration.
eutra-CGI-Reporting-HSDN-ENDC: may be a parameter that defines the capability of reading system information of a neighbor cell according to TS 36.331, acquiring HSDN cell information from a neighboring E-UTRA cell, and reporting the acquired information to the base station in case that (NG)EN-DC is configured and the MN and SN have different DRX cycles, or in case that the MN and SN have the same DRX cycle, but the on-duration configured by the MN does not include the on-duration configured by the SN. This parameter defines whether the UE supports acquisition of HSDN cell information from a neighbouring E-UTRA cell by reading the SI of the neighbouring cell and reporting the acquired information to the network as specified in TS 36.331 when the (NG)EN-DC is configured where either MN and SN have different DRX cycles, or on-duration configured by MN does not contain on-duration configured by SN if their DRX cycles are same.

In step 1h-13, the UE 1h-01 may have (NG)EN-DC configured therefor. For example, the base station 1h-02 may be an LTE base station, and the base station 1h-03 may be an NR base station. NGEN-DC may refer to a case in which a connection is established to a 5G core (5GC), and EN-DC may refer to a case in which a connection is established to an evolved packet core (EPC). For example, the base station 1h-02 may be the MN, and the base station 1h-03 may be the SN.

In step 1h-15, the base station 1h-02 may transmit a predetermined RRC message including measurement configuration information (for example, measConfig) to the UE 1h-01. The predetermined RRC message may include an RRC connection reconfiguration message (RRCConnectionReconfiguration) or an RRC connection resumption message (RRCConnectionResume). In this embodiment, the gNB 1h-02 may set the purpose to reportCGI in reportConfigEUTRA, and may include PhysCellId of cellForWhichToReport in MeasObjectEUTRA associated with reportCGI.

In step 1h-20, the UE 1h-01 may apply measurement configuration information received from the base station 1h-02.

In step 1h-25, the UE 1h-01 may perform measurement by applying the measurement configuration information received in step 1h-20.

In step 1h-30, the UE 1h-01 may determine whether a measurement report is triggered.

In step 1h-35, the UE 1h-01 may transmit a measurement report message (e.g., MeasurementReport message) to the base station 1h-02. The UE 1h-01 may configure measResult in a measurement report message with regard to each measId which triggered the measurement reporting procedure. For example, the UE 1h-01 may set the measurement identity that triggered the measurement report as measId. If there is at least one applicable neighboring cell to report, and in case that the purpose is set to reportCGI and the measObject associated with reportCGI is related to RAT other than NR (else if the purpose is set to reportCGI and the corresponding measObject concerns a RAT other than NR), the UE 1h-01 according to the disclosure may perform at least one of the following options and transmit the same to the base station 1h-02 through a measurement report message (MeasurementReport message).
Option 1: in case that hsdn-Cell is broadcast in system information only if the mandatory present fields of the cgi-Info for the cell indicated by the cellForWhichToReportCGI in the associated measObject have been obtained, the UE 1h-01 may include hsdn-Cell in the measurement report message. For example, the UE 1h-01 may refer to a UE configured such that an E-UTRA cell can read hsdn-Cell which is broadcast in system information 1 (SystemInformationBlockType1) according to step 1h-10 and transmit the same to the base station.
Option 2: in case that hsdn-Cell is broadcast in system information only if mandatory presence fields regarding cgi-Info of the cell indicated by cellForWhichToReportCGI in association with a specific measObject are acquired, and if the si-RequestHO is configured within the reportConfig associated with this measId, the UE 1h-01 may include hsdn-Cell in the measurement report message.
Option 3: in the case that hsdn-Cell is acquired from the cell indicated in cellForWhichToReportCGI in association with a specific measObject, the UE 1h-01 may include hsdn-Cell in a measurement report message.
Option 4: The UE 1h-01 may include all fields successfully acquired from the cell indicated in cellForWhichToReportCGI in association with a specific measObject, in cgi-Info. In addition, the UE 1h-01 may include cgi-Info in the measurement report message. In case that the UE 1h-01 has acquired hsdn-Cell from the corresponding cell, the UE 1h-01 may include the hsdn-Cell together.

FIG. 1I illustrates a diagram depicting a procedure in which a UE in an RRC connected mode (RRC_CONNECTED) in a wireless communication system transmits an indicator indicating an HSDN cell to a base station through a measurement report message for the sake of ANR according to an embodiment of the disclosure.

Referring to FIG. 1I, the UE 1i-01 may be in an RRC connected mode (RRC_CONNECTED) by establishing an RRC connection (1i-05) with the base station 1i-02.

In step 1i-10, the UE 1i-01 may transmit a UE capability information message (for example, UECapabilityInformation) to the base station 1i-02 through a UE capability transfer procedure. The capability parameters included in the UE capability information message may follow at least one of the above-described embodiments. Additionally, in the disclosure, at least one of the following capability parameters may be included in the message. Obviously, the following examples are not limiting.
reportCGI-NR-NoEN-DC: may be a parameter that defines the capability of reading system information of a neighbor cell in case that (NG)EN-DC is not configured according to TS 36.331, acquiring related information from a neighboring NR cell, and reporting the acquired information to the base station. This parameter defines whether the UE supports acquisition of relevant information from a neighbouring NR cell by reading the SI of the neighbouring cell and reporting the acquired information to the network as specified in TS 36.331 when the (NG)EN-DC is not configured.
reportCGI-NR-EN-DC: may be a parameter that defines the capability of reading system information of a neighbor cell in case that (NG)EN-DC is configured according to TS 36.331, acquiring related information from a neighboring NR cell, and reporting the acquired information to the base station. This parameter defines whether the UE supports acquisition of relevant information from a neighbouring NR cell by reading the SI of the neighbouring cell and reporting the acquired information to the network as specified in TS 36.331 when the (NG)EN-DC is configured.
reportCGI-NR-HSDN: may be a parameter that defines the capability of reading system information of a neighbor cell according to TS 36.331, acquiring HSDN cell information from a neighboring NR cell, and reporting the acquired information to the base station. This parameter defines whether the UE supports acquisition of HSDN cell information from a neighbouring NR cell by reading the SI of the neighbouring cell and reporting the acquired information to the network as specified in TS 36.331. The capability parameter may indicate that the parameter is supported only when (NG)EN-DC is not configured, or that the parameter is supported regardless of whether (NG)EN-DC is configured or not. Alternatively, whether or not to support the parameter may be determined according to whether reportCGI-NR-EN-DC and reportCGI-NR-NoEN-DC are supported. Specifically, in case that reportCGI-NR-EN-DC and reportCGI-NR-HSDN are supported, the reportCGI-NR-HSDN capability may be supported in case that (NG)EN-DC is configured. Alternatively, in case of supporting reportCGI-NR-NoEN-DC and reportCGI-NR-HSDN, the reportCGI-NR-HSDN capability may be supported in case that (NG)EN-DC is not configured.
reportCGI-NR-NoEN-DC: may be a parameter that defines the capability of acquiring HSDN cell information from a neighboring NR cell in case that (NG)EN-DC is not configured according to TS 36.331, and reporting the acquired information to the base station. This parameter defines whether the UE supports acquisition of HSDN cell information from a neighbouring NR cell by reading the SI of the neighbouring cell and reporting the acquired information to the network as specified in TS 36.331 when (NG)EN-DC is not configured.
reportCGI-NR-EN-DC: may be a parameter that defines the capability of acquiring HSDN cell information from a neighboring NR cell in case that (NG)EN-DC is configured according to TS 36.331, and reporting the acquired information to the base station. This parameter defines whether the UE supports acquisition of HSDN cell information from a neighbouring NR cell by reading the SI of the neighbouring cell and reporting the acquired information to the network as specified in TS 36.331 when (NG)EN-DC is configured.

In step 1i-13, (NG)EN-DC may be configured for the UE 1i-01. For example, the base station 1i-02 may be an LTE base station, and the base station 1i-03 may be an NR base station. NGEN-DC may refer to a case in which a connection is made to 5GC, and EN-DC may refer to a case in which a connection is made to EPC. For reference, the base station 1i-02 may be the MN, and the base station 1i-03 may be the SN.

In step 1i-14, the NR base station 1i-03 may transmit a CG-Config message to the LTE base station 1i-02. The CG-Config message may include reportCGI-RequestNR. Specific descriptions thereof may follow at least one of the above-described embodiments.

In step 1i-15, the LTE base station 1i-02 may transmit a predetermined RRC message including measurement configuration information (e.g., measConfig) to the UE 1i-01. The predetermined RRC message may include an RRC connection reconfiguration message (RRCConnectionReconfiguration) or an RRC connection resumption message (RRCConnectionResume). In this embodiment, the LTE base station 1i-02 may set the purpose to reportCGI in reportConfigInterRAT, and may include PhysCellIdNR of cellForWhichToReport in MeasObjectNR associated with reportCGI.

In step 1i-20, the UE 1i-01 may apply the measurement configuration information received from the base station 1i-02.

In step 1i-25, the UE 1i-01 may perform measurement by applying the measurement configuration information received in step 1i-20.

In step 1i-30, the UE 1i-01 may determine whether a measurement report is triggered.

In step 1i-35, the UE 1i-01 may transmit a measurement report message (e.g., MeasurementReport message) to the base station 1i-02. The UE 1i-01 may include measResult in the measurement report message with regard to each measId that triggered the measurement reporting procedure. For example, the UE 1i-01 may set the measurement identity that has triggered the measurement report as measId. If there is at least one applicable neighboring cell to report, and in case that the purpose is set to reportCGI and the measObject associated with reportCGI is NR RAT (else if the purpose is set to reportCGI and the corresponding measObject concerns NR RAT), the UE 1i-01 according to the disclosure may transmit a measurement report message to the base station 1i-02 by performing at least one of the following options:
Option 1: in case that hsdn-Cell is broadcast in system information only if the Cell information of cgi-Info for the cell indicated by the cellForWhichToReportCGI in the associated measObject has been obtained, the UE 1i-01 may include the hsdn-Cell in the measurement report message. For example, the UE 1i-01 may refer to a UE configured such that an NR cell can read hsdn-Cell that is broadcast in system information 1 (SIB1) and transmit the same to a base station according to step 1i-10. For example, operations regarding option 1 may be as in Table 2 below. Obviously, the following example is not limiting.

TABLE 2

| | |
|---|---|
| 3> | else if the purpose is set to reportCGI and the corresponding measO |

bject concerns NR RAT:

| | |
|---|---|
| 4> | if the Cell information of cgi-Info for the cell indicated by the cellFo |

rWhichToReportCGI in the associated measObject has been obtained:

| | |
|---|---|
| 5> | include plmn-IdentityInfoList including plmn-IdentityList, t |

```
    rackingAreaCode (if available), ran-AreaCode (if available) and cellIdentity
    for each entry of the plmn-IdentityInfoList;
```

| | |
|---|---|
| 5> | include frequencyBandList if broadcasted; |
| 5> | for each entry in plmn-IdentityInfoList, if the gNB-ID-Lengt |

h is broadcasted:

| | |
|---|---|
| 6> | include gNB-ID-Length; |
| 5> | include hsdn-Cell, if broadcasted; |

Option 2: in case that the UE 1i-01 has acquired hsdn-Cell from the cell indicated in cellForWhichToReportCGI in association with a specific measObject, the UE 1i-01 may include the hsdn-Cell in the measurement report message. For example, operations regarding option 2 may be as in Table 3 below. Obviously, the following example is not limiting.

TABLE 3

| | |
|---|---|
| 3> | else if the purpose is set to reportCGI and the corresponding measO |

bject concerns NR RAT:

| | |
|---|---|
| 4> | if the Cell information of cgi-Info for the cell indicated by the cellFo |

rWhichToReportCGI in the associated measObject has been obtained:

| | |
|---|---|
| 5> | include plmn-IdentityInfoList including plmn-IdentityList, t |

```
    rackingAreaCode (if available), ran-AreaCode (if available) and cellIdentity
    for each entry of the plmn-IdentityInfoList;
```

| | |
|---|---|
| 5> | include frequencyBandList if broadcasted; |
| 5> | for each entry in plmn-IdentityInfoList, if the gNB-ID-Lengt |

h is broadcasted:

| | |
|---|---|
| 6> | include gNB-ID-Length; |

| | |
|---|---|
| 4> | include hsdn-Cell, if broadcasted; |

For reference, the option 1 or option 2 may be performed only in case that SIB1 is broadcast. For example, in case of performing option 1 or option 2, the UE 1i-01 may not perform the following detailed operations.
else if MIB associated with the concerned measObject indicates that SIB1 is not broadcast, include the noSIB1 field.

In step 1i-40, the LTE base station 1i-02 may transmit CG-ConfigInfo to the NR base station 1i-03. CG-ConfigInfo may include measResultReportCGI. The measResultReportCGI may include at least one of the following parameters:
ssbFrequency: an ARFCN-ValueNR value regarding NR may be included as an ssb frequency. The ssb frequency may have the same as in step 1i-14.
cellForWhichToReportCGI: a PhysCellId value which is a physical cell identity regarding a CGI reporting regarding a particular cell may be included.
cgi-Info: CGI-InfoNR which indicates CGI information regarding PhysCellId in the ssb frequency may be included. The CGI-InfoNR may include hsdn-Cell information. Obviously, in case that the LTE base station 1i-02 cannot transfer hsdn-Cell information to the NR base station 1i-03 in reportCGI configured by the SN in (NG)EN-DC, the hsdn-Cell information may not be included in cgi-Info.

FIG. 1J illustrates a flowchart depicting a UE in an RRC connected mode (RRC_CONNECTED) in a wireless communication system performing measurement logging according to an embodiment of the disclosure.

Referring to FIG. 1J, the UE 1j-01 may have an RRC connection established with the gNB 1j-02 and thus be in an RRC connected mode (RRC_CONNECTED) 1j-05.

In step 1j-10, the UE 1j-01 may transmit a UE capability information message (e.g., UECapabilityInformation) to the base station 1j-02 through a UE capability transfer procedure. In the disclosure, the following capability parameters may be included in the UE capability information message.
A capability parameter indicating the capability of logging the hsdn-Cell indicator included in SIBI broadcast in an NR cell or E-UTRA cell in an RRC idle mode (RRC_IDLE) or RRC inactive mode (RRC_INACTIVE).

In step 1j-15, the RRC connected mode UE 1j-01 may receive a LoggedMeasurementConfiguration message from the base station 1j-02. In an embodiment, in case that the hsdn-Cell indicator is broadcast in SIB1 in the LoggedMeasurementConfiguration message, the UE 1j-01 may include an indicator (hsdn-CellIndication) indicating that the hsdn-Cell is to be logged. For example, the UE 1j-01 may store the hsdn-Cell in VarLogMeasConfig. Specifically, upon receiving the LoggedMeasurementConfiguration message, the UE 1j-01 may perform the following procedure in Table 4 below:

TABLE 4

| | |
|---|---|
| 1> | discard the logged measurement configuration as well as the logged measure |

ment information as specified in 5.5a.2;

| | |
|---|---|
| 1> | store the received loggingDuration, reportType and areaConfiguration, if inc |

luded, in VarLogMeasConfig;

| 1> | If the UE is in SNPN access mode: | |
|---|---|---|
| | 2> | if the LoggedMeasurementConfiguration message includes snpn-Co |

nfigList:

| | |
|---|---|
| 3> | set the snpn-ConfigID-List in VarLogMeasReport to include the curr |

ent registered SNPN identity as well as SNPN identities in snpn-Config-List,

| | |
|---|---|
| 2> | else: |
| 3> | set the snpn-ConfigID-List in VarLogMeasReport to include the curr |

ent registered SNPN identity;

| | |
|---|---|
| 1> | else if the LoggedMeasurementConfiguration message includes plmn-Identity |

List:

| | |
|---|---|
| 2> | set plmn-IdentityList in VarLogMeasReport to include the RPLMN a |

s well as the PLMNs included in plmn-IdentityList,

| 1> | else: | |
|---|---|---|
| | 2> | set plmn-IdentityList in VarLogMeasReport to include the RPLMN; |

| | |
|---|---|
| 1> | store the received absolute TimeInfo, traceReference, traceRecordingSessionR |

ef, and tce-Id in VarLogMeasReport;

| | |
|---|---|
| 1> | store the received bt-NameList, if included, in VarLogMeasConfig; |
| 1> | store the received wlan-NameList, if included, in VarLogMeasConfig; |
| 1> | store the received sensor-NameList, if included, in VarLogMeasConfig; |
| 1> | start timer T330 with the timer value set to the loggingDuration; |
| 1> | store the received sigLoggedMeasType, if included, in VarLogMeasReport, |
| 1> | store the received earlyMeasIndication, if included, in VarLogMeasConfig; |
| 1> | store the received hsdn-CellIndication, if included, in VarLogMeasConfig; |

In step 1j-20, the UE 1j-01 may receive an RRC connection release message from the base station 1j-02.

In step 1j-25, the UE 1j-01 may apply the RRC connection release message and transition to an RRC_IDLE or RRC_INACTIVE mode. Specifically, in case that the RRC connection release message includes suspended configuration information (for example, suspendConfig), the UE 1j-01 may transition to the RRC inactive mode, and if not, the UE 1j-01 may transition to the RRC idle mode.

In step 1j-30, the UE 1j-01 in the RRC idle mode or RRC inactive mode may perform the procedure of Table 5 below in case that the T330 timer driven in step 1j-15 keeps driving, and there is no ongoing small data transmission (SDT) procedure.

TABLE 5

| 1> | if measurement logging is suspended: | |
|---|---|---|
| | 2> | if during the last logging interval the IDC problems detected by the |

UE is resolved, resume measurement logging;

| | |
|---|---|
| 1> | if not suspended, perform the logging in accordance with the followi |

ng:

| | |
|---|---|
| 2> | if the reportType is set to periodical in the VarLogMeasConfig: |
| 3> | if the UE is in any cell selection state (as specified in TS 38.304 [20]): |
| 4> | perform the logging at regular time intervals, as defined by the loggi |

ngInterval in the VarLogMeasConfig;

| | |
|---|---|
| 3> | if the UE is in camped normally state on an NR cell and if the RPLM |

N is included in plmn-IdentityList stored in VarLogMeasReport, or

| | |
|---|---|
| 3> | if the UE is in camped normally state on an NR cell and if the regist |

```
  ered SNPN identity is included in snpn-ConfigID-List stored in VarLogMeasRepor
  t:
```

| | |
|---|---|
| 4> | if areaConfiguration is not included in VarLogMeasConfig, or |
| 4> | if the serving cell is part of the area indicated by areaConfig in area |

Configuration in VarLogMeasConfig; or

| | |
|---|---|
| 4> | if the serving cell is part of the area indicated by cag-ConfigList in a |

reaConfiguration in VarLogMeasConfig, or

| | |
|---|---|
| 4> | if the serving cell is part of the area indicated by snpn-ConfigList in |

areaConfiguration in VarLogMeasConfig:

| | |
|---|---|
| 5> | perform the logging at regular time intervals, as defined by |

| the loggingInterval in the VarLogMeasConfig; | |
|---|---|
| 2> | else if the reportType is set to eventTriggered, and eventType is set to |

outOfCoverage:

| | |
|---|---|
| 3> | perform the logging at regular time intervals as defined by the loggi |

ngInterval in VarLogMeasConfig only when the UE is in any cell selection state;

| | |
|---|---|
| 3> | upon transition from any cell selection state to camped normally stat |

e in NR:

| | |
|---|---|
| 4> | if the RPLMN is included in plmn-IdentityList stored in VarLogMea |

```
    sReport, or if the registered SNPN identity is included in snpn-ConfigID-List sto
    red in VarLogMeasReport, and
```

| | |
|---|---|
| 4> | if areaConfiguration is not included in VarLogMeasConfig or if the |

```
    current camping cell is part of the area indicated by areaConfig of areaConfigur
    ation in VarLogMeasConfig, or if the current camping cell is part of the area ind
    icated by cag-ConfigList of areaConfiguration in VarLogMeasConfig, or if the c
    urrent camping cell is part of the area indicated by snpn-ConfigList of areaConfi
    guration in VarLogMeasConfig:
```

| | |
|---|---|
| 5> | perform the logging; |

| | |
|---|---|
| 2> | else if the reportType is set to eventTriggered and eventType is set to |

eventL1:

| | |
|---|---|
| 3> | if the UE is in camped normally state on an NR cell and if the RPLM |

N is included in plmn-IdentityList stored in VarLogMeasReport, or

| | |
|---|---|
| 3> | if the UE is in camped normally state on an NR cell and if the regist |

```
  ered SNPN identity is included in snpn-ConfigID-List stored in VarLogMeasRepor
  t:
```

| | |
|---|---|
| 4> | if areaConfiguration is not included in VarLogMeasConfig; or |
| 4> | if the serving cell is part of the area indicated by areaConfig in area |

Configuration in VarLogMeasConfig; or

| | |
|---|---|
| 4> | if the current serving cell is part of the area indicated by cag-Config |

```
    List of areaConfiguration in VarLogMeasConfig, or if the current camping cell i
    s part of the area indicated by snpn-ConfigList of areaConfiguration in VarLogM
    easConfig;
```

| | |
|---|---|
| 5> | perform the logging at regular time intervals as defined by t |

| he loggingInterval in VarLogMeasConfig only when the conditions indicated | |
|---|---|
| by the eventL1 are met; | |
| 2> | when performing the logging: |
| 3> | if InterFreqTargetInfo is configured and if the UE detected IDC proble |

```
  ms on at least one of the frequencies included in InterFreqTargetInfo or any inter-R
  AT frequency during the last logging interval, or
```

| | |
|---|---|
| 3> | if InterFreqTargetInfo is not configured and if the UE detected IDC |

problems during the last logging interval:

| | |
|---|---|
| 4> | if measResultServingCell in the VarLogMeasReport is not empty: |

| | |
|---|---|
| 5> | include inDeviceCoexDetected; |
| 5> | suspend measurement logging from the next logging interv |

al;

| | |
|---|---|
| 4> | else: |

| | |
|---|---|
| 5> | suspend measurement logging; |

| | |
|---|---|
| 3> | set the relativeTimeStamp to indicate the elapsed time since the mom |

ent at which the logged measurement configuration was received;

| | |
|---|---|
| 3> | if location information became available during the last logging inte |

rval, set the content of the locationInfo as in 5.3.3.7:

| | |
|---|---|
| 3> | if the UE is in any cell selection state (as specified in TS 38.304): |
| 4> | set anyCellSelectionDetected to indicate the detection of no suitable |

or no acceptable cell found;

| | |
|---|---|
| 4> | if the reportType is set to eventTriggered in the VarLogMeasConfig; |

and

| | |
|---|---|
| 4> | if the RPLMN at the time of entering the any cell selection state is in |

```
    cluded in plmn-IdentityList stored in VarLogMeasReport or if the registered SNP
    N identity at the time of entering the any cell selection state is included in snpn-
    ConfigID-List stored in VarLogMeasReport, and
```

| | |
|---|---|
| 4> | if areaConfiguration is not included in VarLogMeasConfig or if the l |

```
    ast suitable cell that the UE was camping on is part of the area indicated by area
    Config of areaConfiguration in VarLogMeasConfig, or if last suitable cell that th
    e UE was camping on is part of the area indicated by cag-ConfigList of areaCon
    figuration in VarLogMeasConfig, or if last suitable cell that the UE was camping
    on is part of the area indicated by snpn-ConfigList of areaConfiguration in VarL
    ogMeasConfig:
```

| | |
|---|---|
| 5> | set the servCellIdentity to indicate global cell identity of the |

last suitable cell that the UE was camping on;

| | |
|---|---|
| 5> | set the measResultServingCell to include the quantities of t |

he last suitable cell the UE was camping on;

| | |
|---|---|
| 4> | else if the reportType is set to periodical in the VarLogMeasConfig: |

| | |
|---|---|
| 5> | set the servCellIdentity to indicate global cell identity of the |

last logged cell that the UE was camping on;

| | |
|---|---|
| 5> | set the measResultServingCell to include the quantities of t |

he last logged cell the UE was camping on;

| | |
|---|---|
| 3> | else: |
| 4> | set the servCellIdentity to indicate global cell identity of the cell the |

UE is camping on;

| | |
|---|---|
| 4> | set the measResultServingCell to include the quantities of the cell th |

e UE is camping on;

| | |
|---|---|
| 3> | if available, set the measResultNeighCells, in order of decreasing ran |

```
  king-criterion as used for cell re-selection, to include measurements of neighbourin
  g cell that became available during the last logging interval and according to the fo
  llowing:
```

| | |
|---|---|
| 4> | include measurement results for at most 6 neighbouring cells on the |

```
    NR serving frequency and for at most 3 cells per NR neighbouring frequency an
    d for the NR neighbouring frequencies in accordance with the following:
```

| | |
|---|---|
| 5> | if interFreqTargetInfo is included in VarLogMeasConfig: |
| 6> | if earlyMeasIndication is included in VarLogMeasConfig; |
| 7> | include measurement results for NR neighbouring frequenc |

```
          ies that are included in both interFreqTargetInfo and either in measIdle
          CarrierListNR (within the VarMeasIdleConfig) or SIB4;
```

| | |
|---|---|
| 6> | else: |
| 7> | include measurement results for NR neighbouring frequenc |

ies that are included in both interFreqTargetInfo and SIB4;

| | |
|---|---|
| 5> | else: |
| 6> | if earlyMeasIndication is included in VarLogMeasConfig; |
| 7> | include measurement results for NR neighbouring frequenc |

```
          ies that are included in either measIdleCarrierListNR (within the VarM
          easIdleConfig) or SIB4;
```

| | |
|---|---|
| 6> | else: |
| 7> | include measurement results for NR neighbouring frequenc |

ies that are included in SIB4;

| | |
|---|---|
| 4> | include measurement results for at most 3 neighbours per inter-RAT |

frequency in accordance with the following:

| | |
|---|---|
| 5> | if earlyMeasIndication is included in VarLogMeasConfig: |
| 6> | include measurement results for inter-RAT neighbouring fre |

```
        quencies that are included in either measIdleCarrierListEUTRA (within th
        e VarMeasIdleConfig) or SIB5;
```

| | |
|---|---|
| 5> | else: |
| 6> | include measurement results for inter-RAT frequencies that |

are included in SIB5;

| | |
|---|---|
| 4> | for each neighbour cell included, include the optional fields that are |

available;

The UE 1j-01 according to the disclosure may log hsdn-Cell in case that the hsdn-Cell indicator is included in SIB1 that is broadcast by the suitable cell which is currently comped on when performing the logging operation, or which has most recently been camped on. For reference, the suitable cell defined according to 3GPP technical specification 38.304 as in Table 6 below:

```
TABLE 6
    suitable cell:
    For UE not operating in SNPN Access Mode, a cell is considered as suitable if the foll
owing conditions are fulfilled:
```

| | |
|---|---|
| - | The cell is part of either the selected PLMN or the registered PLMN or PLM |

N of the Equivalent PLMN list, and for that PLMN either:

| | |
|---|---|
| - | The PLMN-ID of that PLMN is broadcast by the cell with no associ |

```
    ated CAG-IDs and CAG-only indication in the UE for that PLMN (TS 23.501) is abse
    nt or false;
```

| | |
|---|---|
| - | Allowed CAG list in the UE for that PLMN (TS 23.501 [10]) includ |

es a CAG-ID broadcast by the cell for that PLMN;

| | |
|---|---|
| - | The cell selection criteria are fulfilled, see clause 5.2.3.2. |

According to the latest information provided by NAS:

| | |
|---|---|
| - | The cell is not barred, see clause 5.3.1; |
| - | The cell is part of at least one TA that is not part of the list of “″Forbidden Tr |

```
  acking Areas for Roaming” (TS 22.011), which belongs to a PLMN that fulfils the first b
  ullet above.
    For UE operating in SNPN Access Mode, a cell is considered as suitable if the followi
ng conditions are fulfilled:
```

| | |
|---|---|
| - | The cell is part of the selected SNPN or the registered SNPN or SNPN of the |

Equivalent SNPN list of the UE;

| | |
|---|---|
| - | The cell selection criteria are fulfilled, see clause 5.2.3.2; |

According to the latest information provided by NAS:

| | |
|---|---|
| - | The cell is not barred, see clause 5.3.1; |
| - | The cell is part of at least one TA that is not part of the list of “Forbidden Tra |

```
  cking Areas for Roaming” which belongs to the selected SNPN or the registered SNPN o
  r SNPN of the Equivalent SNPN list of the UE.
```

In step 1j-35, the UE 1j-01 may transition to an RRC connected mode through an RRC connection establishment procedure or an RRC connection resume procedure with the base station 1j-02.

In step 1j-40, the base station 1j-02 may transmit a UEInformationRequest message to the UE 1j-01 in order to recover the logged measurement result from the UE 1j-01. The UEInformationRequest message may contain logMeasReportReq.

In step 1j-45, the UE 1j-01 may transmit a UEInformationResponse message including the measurement result logged in step 1j-30 to the base station 1j-202. Specifically, the UE 1j-01 may perform the procedure in Table 7 below:

TABLE 7

| | |
|---|---|
| 1> | if the logMeasReportReq is present and if the RPLMN is included in plmn-Id |

entityList stored in VarLogMeasReport, or if the current registered SNPN identity is inclu
ded in snpn-ConfigID-List stored in VarLogMeasReport:

| | |
|---|---|
| 2> | if VarLogMeasReport includes one or more logged measurement ent |

ries, set the contents of the logMeasReport in the UEInformationResponse message as

follows:

| | |
|---|---|
| 3> | include the absoluteTimeStamp and set it to the value of |

absoluteTimeInfo in the VarLogMeasReport;

| | |
|---|---|
| 3> | include the traceReference and set it to the value of traceReference |

in the VarLogMeasReport,

| | |
|---|---|
| 3> | include the traceRecordingSessionRef and set it to the value of |

traceRecordingSessionRef in the VarLogMeasReport;

| | 3> | include the tce-Id and set it to the value of tce-Id in the VarLogMeas |
|---|---|---|
| Report; | | |

| | |
|---|---|
| 3> | include the logMeasInfoList and set it to include one or more entries |

```
    from the VarLogMeasReport starting from the entries logged first, and for each entr
    y of the logMeasInfoList that is included, include all information stored in the corre
    sponding logMeasInfoList entry in VarLogMeasReport;
```

| | |
|---|---|
| 3> | if the VarLogMeasReport includes one or more additional logged me |

```
    asurement entries that are not included in the logMeasInfoList within the UEInform
    ationResponse message:
```

| | |
|---|---|
| 4> | include the logMeasAvailable; |
| 4> | if bt-LocationInfo is included in locationInfo of one or more of the a |

```
      dditional logged measurement entries in VarLogMeasReport that are not include
      d in the logMeasInfoList within the UEInformationResponse message:
```

| | |
|---|---|
| 5> | include the logMeasAvailableBT; |

| | |
|---|---|
| 4> | if wlan-LocationInfo is included in locationInfo of one or more of th |

```
      e additional logged measurement entries in VarLogMeasReport that are not inclu
      ded in the logMeasInfoList within the UEInformationResponse message:
```

| | |
|---|---|
| 5> | include the logMeasAvailableWLAN; |

The UE 1j-01 according to the disclosure may transmit the logged measurement including the hsdn-Cell indicator to the base station 1j-02.

FIG. 1K is a block diagram illustrating a structure of an NR base station according to an embodiment of the disclosure.

As illustrated in FIG. 1K, the base station may include an RF processor 1k-10, a baseband processor 1k-20, a backhaul communication unit 1k-30, a storage 1k-40, and a controller 1k-50. Of course, the example given above is not limiting, and the base station may include a smaller or larger number of components than the components illustrated in FIG. 1K.

The RF processor 1k-10 may perform functions for transmitting/receiving signals through a radio channel, such as signal band conversion and amplification. That is, the RF processor 1k-10 may up-convert a baseband signal provided from the baseband processor 1k-20 to an RF band signal, transmit the same through an antenna, and down-convert an RF band signal received through the antenna to a baseband signal. For example, the RF processor 1k-10 may include a transmission filter, a reception filter, an amplifier, a mixer, an oscillator, a DAC, and an ADC. Although only one antenna is illustrated in the drawing, the first access node may include multiple antennas. In addition, the RF processor 1k-10 may include multiple RF chains. Furthermore, the RF processor 1k-10 may perform beamforming. For the beamforming, the RF processor 1k-10 may adjust the phase and magnitude of signals transmitted/received through multiple antennas or antenna elements, respectively. The RF processor may transmit one or more layers to perform a downward MIMO operation.

The baseband processor 1k-20 may perform functions of conversion between baseband signals and bitstrings according to the physical layer specifications of a first radio access technology. For example, during data transmission, the baseband processor 1k-20 may encode and modulate a transmitted bitstring to generate complex symbols. Further, during data reception, the baseband processor 1k-20 may demodulate and decode a baseband signal provided from the RF processor 1k-10 to restore a received bitstring. For example, when following the OFDM scheme, during data transmission, the baseband processor 1k-20 may encode and modulate a transmitted bitstring to generate complex symbols, map the complex symbols to subcarriers, and configure OFDM symbols through IFFT operation and CP insertion. In addition, during data reception, the baseband processor 1k-20 may split a baseband signal provided from the RF processor 1k-10 at the OFDM symbol level, restore signals mapped to subcarriers through FFT operation, and restore a received bitstring through demodulation and decoding. The baseband processor 1k-20 and the RF processor 1k-10 may transmit and receive signals as described above. Therefore, the baseband processor 1k-20 and the RF processor 1k-10 may be referred to as a transmitter, a receiver, a transceiver, or a communication unit.

The backhaul communication unit 1k-30 provides an interface for communicating with other nodes in the network. That is, the backhaul communication unit 1k-30 converts bitstrings transmitted from the main base station to other nodes, for example, an auxiliary base station, a core network, etc., into physical signals, and converts physical signals received from the other nodes into bitstrings.

The storage 1k-40 may store basic programs, application programs, and data, such as configuration information, for operation of the main base station. Particularly, the storage 1k-40 may store information regarding a bearer allocated to a connected UE, a measurement result reported from the connected UE, and the like. Also, the storage 1k-40 may store information serving as criteria for determining whether to provide multi-connection to a UE or to suspend the same. Further, the storage 1k-40 may provide the stored data at the request of the controller 1k-50. In addition, the storage 1k-40 may provide the stored data at the request of the controller 1k-50. The storage 1k-40 may be configured by storage media such as a ROM, a RAM, a hard disk, a CD-ROM, and a DVD, or a combination of storage media. Furthermore, the storage 1k-40 may be configured by multiple memories. According to an embodiment, the storage 1k-40 may store programs for performing the method set forth herein.

The controller 1k-50 controls the overall operation of the main base station. For example, the controller 1k-50 transmits/receives signals through the baseband processor 1k-20 and the RF processor 1k-10 or through the backhaul communication unit 1k-30. Further, the controller 1k-50 records data in the storage 1k-40 and reads the data from the storage 1k-40. To this end, the controller 1k-50 may include at least one processor. Also, at least one component in the base station may be implemented as a single chip. In addition, according to an embodiment of the disclosure, the controller 1k-50 may include a multi-connectivity processor 1k-52 configured to perform processing for operating in a multi-connectivity mode. The controller 1k-50 may control the operation of the base station or an entity corresponding thereto according to various embodiments of the disclosure.

FIG. 1L illustrates an internal structure of a UE according to an embodiment of the disclosure.

Referring to FIG. 1L, the UE may include a radio frequency (RF) processor 1l-10, a baseband processor 1l-20, a storage 1l-30, and a controller 1l-40. Of course, the example given above is not limiting, and the UE may include a smaller or larger number of components than the components illustrated in FIG. 1L.

The RF processor 1l-10 may perform functions for transmitting/receiving signals through a radio channel, such as signal band conversion and amplification. That is, the RF processor 1l-10 may up-convert a baseband signal provided from the baseband processor 1l-20 to an RF band signal, transmit the same through an antenna, and down-convert an RF band signal received through the antenna to a baseband signal. For example, the RF processor 1l-10 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. Further, the RF processor 1l-10 may include multiple RF chains. Furthermore, the RF processor 1l-10 may perform beamforming. For the beamforming, the RF processor 1l-10 may adjust the phase and magnitude of signals transmitted/received through multiple antennas or antenna elements, respectively. In addition, the RF processor may perform MIMO and receive multiple layers when performing a MIMO operation. The RF processor 1l-10 may appropriately configure multiple antennas or antenna elements to perform reception beam sweeping or may adjust the direction and beam width of a reception beam so as to resonate the reception beam with a transmission beam under the control of the controller.

The baseband processor 1l-20 may perform functions of conversion between baseband signals and bitstrings according to the physical layer specifications of the system. For example, during data transmission, the baseband processor 1l-20 may encode and modulate a transmitted bitstring to generate complex symbols. Further, during data reception, the baseband processor 1l-20 may demodulate and decode a baseband signal provided from the RF processor 1l-10 to restore a received bitstring. For example, when following the orthogonal frequency division multiplexing (OFDM) scheme, during data transmission, the baseband processor 1l-20 may encode and modulate a transmitted bitstring to generate complex symbols, map the complex symbols to subcarriers, and configure OFDM symbols through inverse fast Fourier transform (IFFT) operation and cyclic prefix (CP) insertion. In addition, during data reception, the baseband processor 1l-20 may split a baseband signal provided from the RF processor 1l-10 at the OFDM symbol level, restore signals mapped to subcarriers through a fast Fourier transform (FFT) operation, and restore a received bitstring through demodulation and decoding.

The baseband processor 1l-20 and the RF processor 1l-10 may transmit and receive signals as described above. Therefore, the baseband processor 1l-20 and the RF processor 1l-10 may be referred to as a transmitter, a receiver, a transceiver, or a communication unit. Furthermore, at least one of the baseband processor 1l-20 and the RF processor 1l-10 may include multiple communication modules to support multiple different radio access technologies. In addition, at least one of the baseband processor 1l-20 and the RF processor 1l-10 may include different communication modules to process signals in different frequency bands. For example, the different radio access technologies may include a wireless LAN (e.g., IEEE 802.11), a cellular network (e.g., LTE), and the like. Also, the different frequency bands may include super high frequency (SHF) (e.g., 2 NRHz) bands and millimeter wave (mm Wave) (e.g., 60 GHz) bands. The UE may transmit/receive signals with the base station by using the baseband processor 1l-20 and the RF processor 1l-10, and the signals may include control information and data.

The storage 1l-30 may store basic programs, application programs, and data, such as configuration information, for operation of the main base station. Particularly, the storage 1l-30 may store information regarding a second access node configured to perform wireless communication by using a second radio access technology. Further, the storage 1l-30 may provide the stored data at the request of the controller 1l-40. In addition, the storage 1l-30 may be configured by multiple memories. According to an embodiment, the storage 1l-30 may store programs for performing the method set forth herein.

The controller 1l-40 controls the overall operation of the UE. For example, the controller 1l-40 may transmit/receive signals through the baseband processor 1l-20 and the RF processor 1l-10. Further, the controller 1l-40 records data in the storage 1l-30 and reads the data from the storage 1l-30. To this end, the controller 1l-40 may include at least one processor. For example, the controller 1l-40 may include a communication processor (CP) configured to perform control for communication, and an application processor (AP) configured to control upper layers such as application programs. In addition, at least one component in the UE may be implemented as a single chip. Furthermore, according to an embodiment of the disclosure, the controller 1l-40 may include a multi-connectivity processor 1l-42 which performs processing for operating in a multi-connectivity mode.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure. In the specific embodiments of the disclosure, the components included in the disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

Meanwhile, while the specific embodiment has been described in the explanations of the disclosure, it will be noted that various changes may be made therein without departing from the scope of the disclosure. Therefore, the scope of the disclosure is not limited and defined by the described embodiment and is defined not only the scope of the claims as below but also their equivalents.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Furthermore, although the above embodiments have been presented based on the frequency division duplex (FDD) LTE system, other variants based on the technical idea of the above embodiments may also be implemented in other systems such as time division duplex (TDD) LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
transmitting, to a first base station, UE capability information associated with a HSDN (high-speed dedicated network) cell;
receiving, from the first base station, configuration information for a measurement report; and
transmitting, to the first base station, the measurement report including a measurement result based on the configuration information,
wherein the measurement report further includes information on the HSDN cell.

2. The method of claim 1, wherein the information on the HSDN cell is included in the measurement report in case that the UE supports the measurement report for the HSDN cell and acquires the HSDN cell for an associated cell from the configuration information.

3. The method of claim 2, wherein the HSDN cell is broadcast from the first base station.

4. The method of claim 1, wherein the UE supports a dual connectivity (DC) for the first base station and a second base station.

5. The method of claim 4, wherein the configuration information is generated from the second base station, and
wherein the information on the HSDN cell is transmitted to the second base station.

6. A method performed by a first base station in a wireless communication system, the method comprising:
receiving, from a user equipment (UE), UE capability information associated with a HSDN (high-speed dedicated network) cell;
transmitting, to the UE, configuration information for a measurement report; and
receiving, from the UE, the measurement report including a measurement result based on the configuration information,
wherein the measurement report further includes information on the HSDN cell.

7. The method of claim 6, wherein the information on the HSDN cell is included in the measurement report in case that the UE supports the measurement report for the HSDN cell and acquires the HSDN cell for an associated cell from the configuration information.

8. The method of claim 7, wherein the HSDN cell is broadcast from the first base station.

9. The method of claim 6, wherein the UE supports a dual connectivity (DC) for the first base station and a second base station.

10. The method of claim 9, further comprising:
receiving, from the second base station, the configuration information; and
transmitting, to the second base station, the information on the HSDN cell.

11. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
transmit, to a first base station, UE capability information associated with a HSDN (high-speed dedicated network) cell,
receive, from the first base station, configuration information for a measurement report, and
transmit, to the first base station, the measurement report including a measurement result based on the configuration information,
wherein the measurement report further includes information on the HSDN cell.

12. The UE of claim 11, wherein the information on the HSDN cell is included in the measurement report in case that the UE supports the measurement report for the HSDN cell and acquires the HSDN cell for an associated cell from the configuration information.

13. The UE of claim 12, wherein the HSDN cell is broadcast from the first base station.

14. The UE of claim 11, wherein the UE supports a dual connectivity (DC) for the first base station and a second base station.

15. The UE of claim 14, wherein the configuration information is generated from the second base station, and
wherein the information on the HSDN cell is transmitted to the second base station.

16. A first base station comprising:
at least one transceiver;
at least one processor communicatively coupled to the at least one transceiver; and
at least one memory, communicatively coupled to the at least one processor, storing instructions executable by the at least one processor individually or in any combination to cause the first base station to:
receive, from a user equipment (UE), UE capability information associated with a HSDN (high-speed dedicated network) cell,
transmit, to the UE, configuration information for a measurement report, and
receive, from the UE, the measurement report including a measurement result based on the configuration information,
wherein the measurement report further includes information on the HSDN cell.

17. The first base station of claim 16, wherein the information on the HSDN cell is included in the measurement report in case that the UE supports the measurement report for the HSDN cell and acquires the HSDN cell for an associated cell from the configuration information.

18. The first base station of claim 17, wherein the HSDN cell is broadcast from the first base station.

19. The first base station of claim 16, wherein the UE supports a dual connectivity (DC) for the first base station and a second base station.

20. The first base station of claim 19, wherein the instructions further cause the first station to:
receive, from the second base station, the configuration information, and
transmit, to the second base station, the information on the HSDN cell.
